(19) United States
(12) Patent Application Publication
(10) Pub. No.: US 2012/0271769 A1
(43) Pub. Date: Oct. 25, 2012

(54) ENCRYPTED BANNER OVERLAYS

(76) Inventors: Solomon Franco, Bat-Chen (IL); Clifton Herman Hicks, JR., Northville, MI (US); Ziv Peres, Oranit (IL); Joseph Rogozinski, Ramat-Gan (IL); Shlomi Levi, Zoran (IL)

(21) Appl. No.: 12/991,697

(22) PCT Filed: May 11, 2009
(86) PCT No.: PCT/IL09/00474

§ 371 Date: Aug. 15, 2011

(30) Foreign Application Priority Data
May 11, 2008 (IL) 191352
Sep. 10, 2008 (IL) 194019

(51) Int. Cl. G06F 21/00; G06Q 30/02

(52) U.S. Cl. 705/57; 705/51

(57) ABSTRACT

A computer session management system operates in conjunction with a host computer, and comprises: i) a safe access module to facilitate safe access to a computer-based application, particularly a network-based application, in conjunction with said host computer; and ii) an advertising module providing advertisements associated with the computer-based application.

### FIELD AND BACKGROUND OF THE INVENTION

The present invention, in some embodiments thereof, relates to network-distributed advertising that download to network computers and, more particularly, but not exclusively, to advertising tags, alternatively referred to as advertising banners, that are overlaid on predetermined areas of network computers.

The continuing expansion of the Internet has led to the now widespread practice of electronic distribution of advertising based upon input of advertising parameters by a consumer, for example product category, desired features and/or desired range of product cost.

The new advertising medium provided by the Internet has a number of significant advantages for advertisers. For example, consumers requesting products via the Internet have, on average, more disposable income to spend on products and services than the average user of other traditional advertising media, such as television or print.

However, the user is limited to viewing embedded advertisements in an ISP network web page, for example Google or AOL. As a result, the user may not be provided with products based upon the user age, gender or personal interests.

While embedding advertisements from advertisers who are not registered with an existing ISP network are known, insertion of such advertising often alters the appearance of the display in a manner that violates the copyright of the display; an illegal offence.

Additionally, the user response to products, for example by clicking a product of interest, leaves a record of Internet files and cookies that serve as beacons to attract computer scammers, junk mail, and computer viruses.

Additional background art relevant includes:
U.S. Pat. Nos. 7,369,864 (Vaananen); 366,996; (Hoyle); and 6,990,630 (Landsman et al); and
U.S. patent application No. 10/304,772 (Ziv, et al), now published as US 2004/0103288; and 60/643,150, (Oh, et al) now published as U.S. 2006/0156036; the contents of which are all incorporated by reference as if fully set forth herein.

### SUMMARY OF THE INVENTION

Disclosed is a computer session management system configured for operating in conjunction with a host computer. The computer session management system includes a safe access module operatively configured to facilitate safe access to at least one computer-based application in conjunction with the host computer and an advertising module configured to provide advertisements associated with the at least one computer-based application.

According to an aspect of some embodiments of the present invention, there is provided a computer session management system configured for operating in conjunction with a host computer, the computer session management system including: an authentication module configured to obtain authentication of the computer session management system with respect to the host computer, a safe access module operatively associated with the authentication module and configured to facilitate safe access to at least one computer-based application in conjunction with the host computer, and an advertising module configured to provide advertisements associated with the at least one computer-based application.

In some embodiments of the invention, the authentication module includes a digital string including at least one of: a session management system identifier, a user login name, a user password, and at least one user profile.

In some embodiments of the invention, the advertising module is provided following user agreement.

In some embodiments of the invention, the advertising module is configured to provide an advertisement according to the at least one user profile.

In some embodiments of the invention, the authentication module includes a digital string associated with at least two user profiles and at least one of: a session management system identifier, a user login name, and a user password, associated with each of the at least two user profiles.

In some embodiments of the invention, the advertising module is provided following agreement of the at least two users.

In some embodiments of the invention, the advertising module is configured to provide an advertisement, each associated with one of the at least two user profiles.

In some embodiments of the invention, the advertising includes at least one of: targeted advertising, and generic advertising.

In some embodiments of the invention, the targeted advertising includes advertisements based upon at least one user preference.

In some embodiments of the invention, the generic advertising includes advertisements based upon at least one user profile component, including at least one of a user: age, gender, income level, product preference, and location.

In some embodiments of the invention, the advertising module is configured to provide an advertisement according to at least one user click on an embedded link associated with at least one of: the at least one computer-based application, and the advertising module.

In some embodiments of the invention, the system includes an encryption engine configured to operate with the host computer to provide encryption of the provided advertisement and the at least one user click on the embedded link associated with at least one of: the at least one computer-based application, and the advertising module.

In some embodiments of the invention, the advertising module is configured to provide advertisements according to at least one keyword entered by a user on at least one of: the at least one computer-based application, and the advertising module.

In some embodiments of the invention, the system includes an encryption engine configured to operate with the host computer to provide encryption of the provided advertisement and the at least one keyword entered by a user on at least one of: the at least one computer-based application, and the advertising module.

In some embodiments of the invention, the encryption occurs following expiration of authentication by the authentication module.

In some embodiments of the invention, the encryption engine is further configured to operate with the host computer in providing an encryption of the at least one computer-based application.

In some embodiments of the invention, the at least one computer-based application includes at least one of: a web page provided by an Internet Service Provider, a web page provided by an Internet Web Browser, and a program resident on the host computer.

In some embodiments of the invention, the system includes a backup manager configured to backup the encryption provided by the encryption engine on the server.

In some embodiments of the invention, the system is configured to communicate with a server located in a remote location with respect to the host computer.

In some embodiments of the invention, the system is configured to communicate with a server at the remote location using at least one of: a wide area network, an Internet channel, and a proxy server.

In some embodiments of the invention, the system includes a remote revealing module configured to reveal at least a portion of the encryption provided by the encryption engine on the server.

In some embodiments of the invention, the remote revealing module is configured to reveal at least one of: an advertising history, a user click history, and a user keyword input history.

In some embodiments of the invention, the remote revealing module is configured to be operated by at least one of: an Operating System provider, an Internet Service Provider (ISP), a Web Browser, and a provider of the computer session management system.

In some embodiments of the invention, the operation is provided following user agreement.

In some embodiments of the invention, the authentication module is associated with at least one of: a portable session management device configured for insertion into an input on the host computer, and a server configured to communicate with the host computer.

In some embodiments of the invention, the system includes an advertisement overlay module configured to overlay the provided advertisements on at least a portion of a display on the host computer.

In some embodiments of the invention, the system includes a copyright module operatively associated with the advertising overlay module configured to determine whether a copyright is associated with the at least a portion of the display on the host computer.

In some embodiments of the invention, copyright module is configured to provide advertisements peripherally to a copyrighted portion of the display on the host computer.

In some embodiments of the invention, the advertisement overlay module is configured to overlay the provided advertisements according to a time parameter including at least one of: time prior to display, time during the display, and time between displays.

In some embodiments of the invention, the advertisement overlay module is configured to overlay the provided advertisements according to a display parameter including at least one of: size of display peripheral to the copyrighted portion, and displayed advertisements to be overlaid.

In some embodiments of the invention, the safe access module is configured to associate with at least one of: a primary Internet site, a secondary Internet site reached via a primary Internet site, and an Internet site reached via an embedded link associated with the host computer.

In some embodiments of the invention, the embedded link associated with the host computer is embedded in at least one of: a computer program, an e-mail, an Internet site, a chat room, an instant message, and a blog.

In some embodiments of the invention, the safe access module is configured to operate on: at least one first host computer, and at least one second host computer.

In some embodiments of the invention, the at least one first host computer operates according to a first operating language, and at least one second host computer operates according to a second operating language.

In some embodiments of the invention, the first operating language includes Microsoft Windows XP, and the second operating language includes Microsoft Vista. In some embodiments of the invention, the safe access module is configured to operate in conjunction with: at least one first Web Browser, and at least one second Web Browser.

In some embodiments of the invention, the safe access module is configured to restart following a time out by at least one of: an ISP, and a Web Browser.

In some embodiments of the invention, the advertising module is configured to provide advertisements associated in: at least one first international language, and at least one second international language.

In some embodiments of the invention, the at least one first international language, and the at least one second international language, include at least one of: German, English, Spanish, Italian, and Russian.

According to another aspect of some embodiments of the present invention, there is provided a method of providing session management, including the steps of: entering an authentication identifier associated with a server, confirming the authentication identifier by a confirmation module; accessing at least one computer-based application using the server, conditionally upon the authentication; and providing at least one advertisement associated with the at least one computer-based application.

According to still another aspect of some embodiments of the present invention, there is provided a computer network management system configured for operating in conjunction with a computer network, the computer network management system including: an authentication module configured to obtain authentication of a host computer with respect to a computer network management system, a safe access module operatively associated with the authentication module and configured to facilitate safe access to at least one computer-based application in conjunction with the computer network, and a gatekeeper associated with the authentication module, the gatekeeper configured to limit access to the computer network based upon parameters associated with the authentication module.

In some embodiments of the invention, the authentication module includes a digital string including at least one of: a session management system identifier, a user login name, a user password, and a user profile.

In some embodiments of the invention, the at least one computer-based application includes an Internet web page provided by at least one of: an Internet Service Provider, and an Internet Web Browser.

In some embodiments of the invention, the at least one computer-based application includes a user-directed communication including at least one user of: an e-mail, a chat room, an instant message, and a blog.

In some embodiments of the invention, the authentication module is associated with at least one of: a portable session management device configured for insertion into an input on the host computer, and a server configured to communicate with the host computer.

According to an additional aspect of some embodiments of the present invention, there is provided a method of providing session management, including the steps of: entering an authentication identifier into a computer network, confirming the authentication identifier by a confirmation module operatively associated with the computer network, providing parameters associated with the authentication identifier to allow access to the computer network; and accessing at least one computer-based application using the computer network, conditionally upon the authentication, based upon the provided parameters.

In some embodiments of the invention, following the entry of the authentication identifier, it is determined to be invalid.

In some embodiments of the invention, the method includes: informing a user associated with the invalid authentication identifier of the invalidity, and sending a message to an authority associated with the computer network regarding the invalidity.

According to a further aspect of some embodiments of the present invention, there is provided a computer session management system configured for operating in conjunction with a host computer, the computer session management system including: an authentication module configured to obtain authentication of the computer session management system with respect to the host computer, a safe access module operatively associated with the authentication module and configured to facilitate safe access to an Internet access program in multiple languages in conjunction with the host computer and maintain a history of the Internet access in multiple languages.

According to a still further aspect of some embodiments of the present invention, there is provided a computer session management system configured for operating in conjunction with a host computer, the computer session management system including: an authentication module configured to obtain authentication of the computer session management system with respect to the host computer, a safe access module operatively associated with the authentication module and configured to automatically facilitate safe access to an Internet access program following a connection, disconnection, and reconnection with the Internet access program.

In some embodiments of the invention, the Internet access program includes at least one of: an Internet Service Provider, an Internet Web Browser.

According to a further additional aspect of some embodiments of the present invention, there is provided a computer session management system configured for operating in conjunction with a host computer, the computer session management system including: an authentication module configured to obtain authentication of the computer session management system with respect to the host computer, a safe access module operatively associated with the authentication module and configured to facilitate safe access to multiple Web browsers during an Internet access session in conjunction with the host computer and maintain a history associated with the multiple Web browsers.

According to still another aspect of some embodiments of the present invention, there is provided a computer session management system configured for operating in conjunction with a host computer, the computer session management system including: an authentication module configured to obtain multiple authentications of the computer session management system with respect to multiple users associated with the host computer, a safe access module operatively associated with the authentication module and configured to facilitate safe access to at least one computer-based application in conjunction with the host computer, and an advertising module configured to provide advertisements associated with the at least one computer-based application according to user profiles of each of the multiple users.

In some embodiments of the invention, the user profiles of each of the multiple users include at least one of a user: age, gender, income level, product preference, and location.

According to a further additional aspect of some embodiments of the present invention, there is provided a computer session management system configured for operating in conjunction with a host computer, the computer session management system including: an authentication module configured to obtain authentication of the computer session management system with respect to the host computer, a safe access module operatively associated with the authentication module and configured to facilitate safe access to at least one computer-based application in conjunction with the host computer, and an advertising module configured to display advertisement overlays associated with the at least one computer-based application based upon at least one control parameter.

In some embodiments of the invention, the at least one control parameter includes at least one of: time prior to display, time during the display, and time between displays.

In some embodiments of the invention, the at least one control parameter includes at least one of: size of display peripheral to a copyrighted portion of the display, and a user profile associated with the safe access module.

According to a still further additional aspect of some embodiments of the present invention, there is provided a computer session management system configured for operating in conjunction with a host computer, the computer session management system including: an authentication module configured to obtain authentication of the computer session management system with respect to the host computer, a safe access module operatively associated with the authentication module and configured to facilitate safe access to at least one computer-based application in conjunction with the host computer, and an advertising module configured to provide, in association with the at least one computer-based application, at least one of: generic advertisements, and targeted advertisements, based upon a user profile associated with the safe access module.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1A shows components of a typical portable session management device;

FIG. 1B shows the portable session management device of FIG. 1A being plugged into a computer;

FIGS. 1C-1D show an overview of the functions of the portable session management device of FIG. 1A, in accordance with embodiments of the invention;

FIG. 1E shows a simplified illustration of the overview of the flow of the a new user setup process, both with and without the portable session management device of FIG. 1A, in accordance with embodiments of the invention;

FIG. 2 shows a simplified view of the processing in the present invention, and how it will be used to replace the advertisements in a web browser, in accordance with embodiments of the invention;

FIG. 3 shows a simplified view of the processing required to gather and grow a user's history, in accordance with embodiments of the invention;

FIG. 4 shows a simplified pictorial illustration of how the present invention will replace advertisements in other applications found on the computer, in accordance with embodiments of the invention;

FIG. 5 shows a flow chart of the start up process for the computer, starting the application to monitor for advertisements, in accordance with embodiments of the invention;

FIG. 6 shows a flow chart for Reviewing Advertisement History, according to some embodiments of the invention;

FIG. 7 shows a flow chart depicting when the user is not connected to internet, according to some embodiments of the invention;

FIG. 8 shows a flow chart depicting government certification for user access, according to some embodiments of the invention;

FIG. 9 shows a flow chart depicting a search override, according to some embodiments of the invention;

FIG. 10 shows an alternate search override flow chart, according to some embodiments of the invention;

FIG. 11 shows a flow chart depicting Internet access in a household, according to some embodiments of the invention;

FIG. 12 shows a flow chart depicting Web surfing through a safe house protection system, according to some embodiments of the invention;

FIG. 13 shows a flow chart depicting re-login verification prior to a program launch, according to some embodiments of the invention;

FIG. 14 shows a flow chart depicting a targeted pop-up side screen, according to some embodiments of the invention;

FIG. 15 shows a Web browser session flowchart, in accordance with embodiments of the invention;

FIG. 16A shows a Display Toolbar Process flowchart which continues from

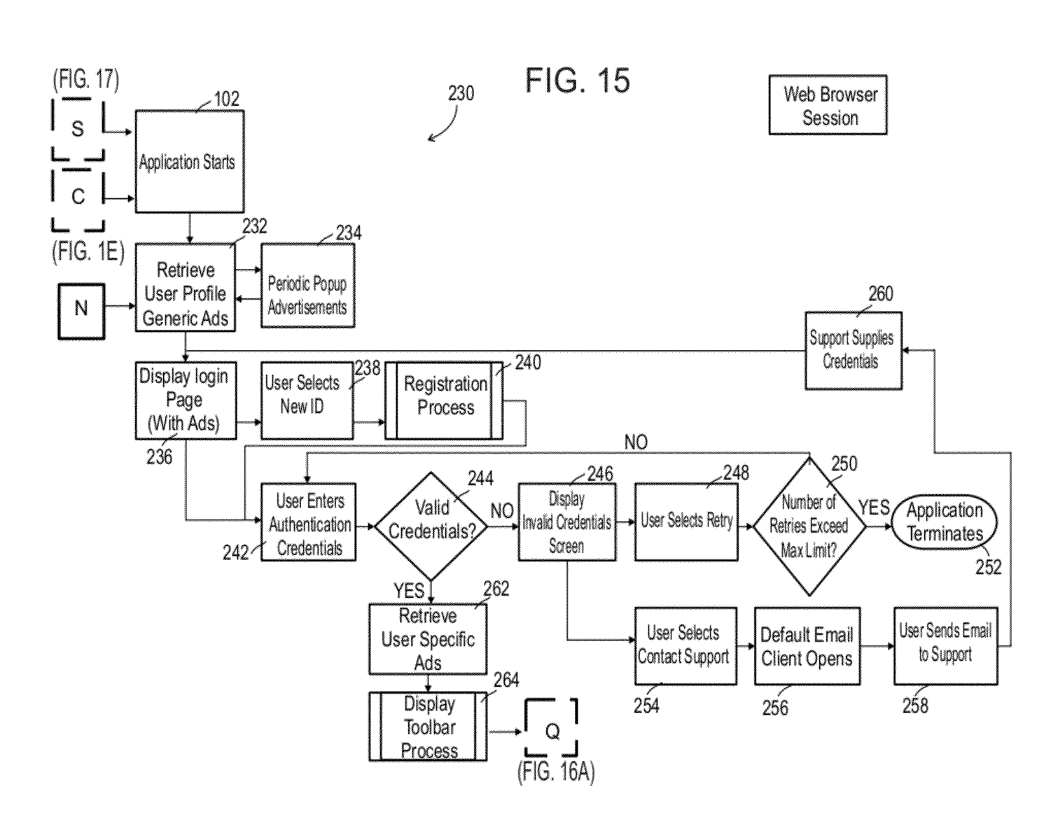

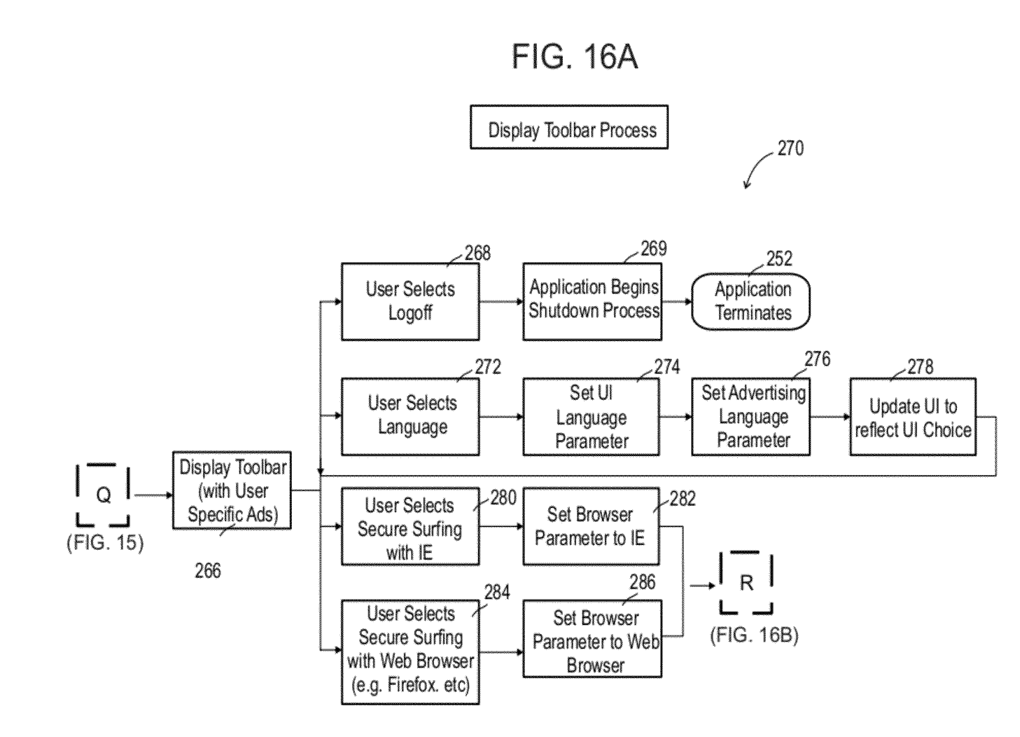

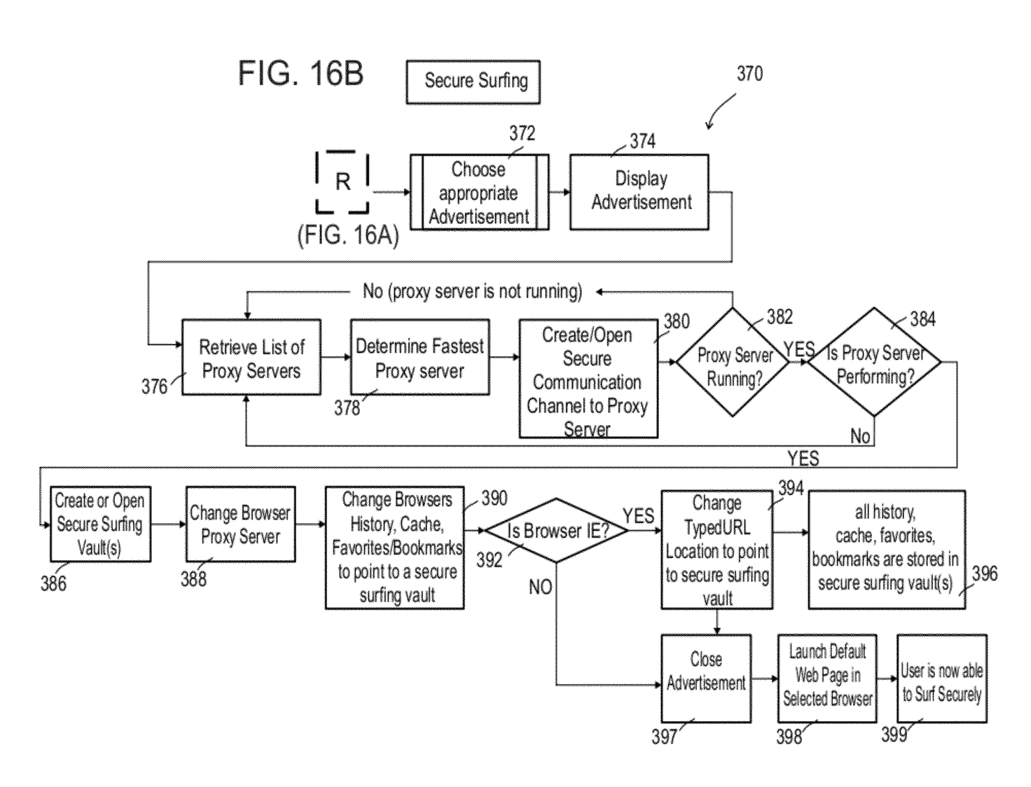

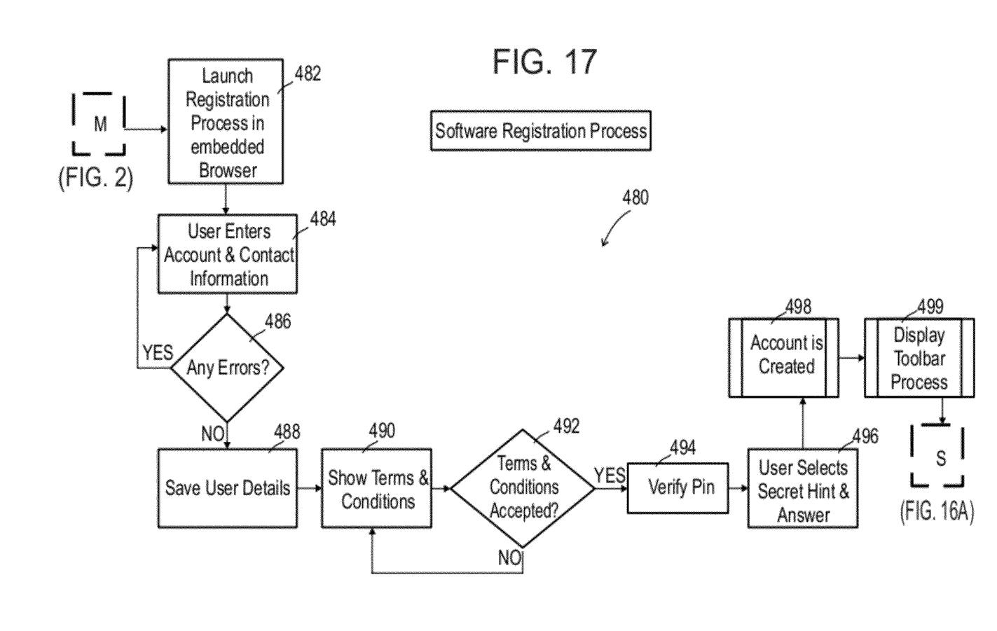

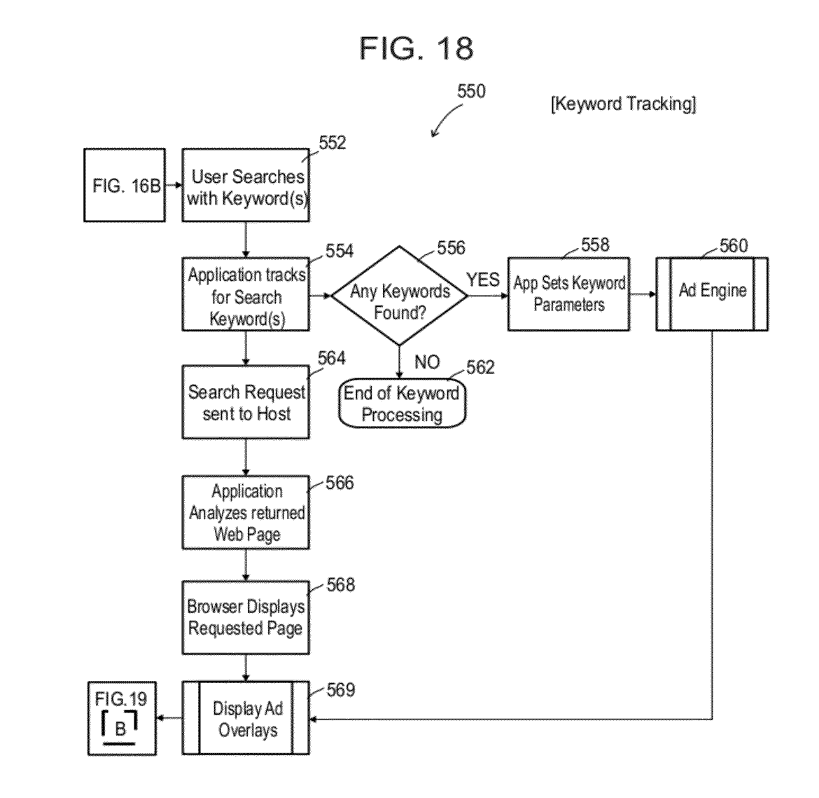

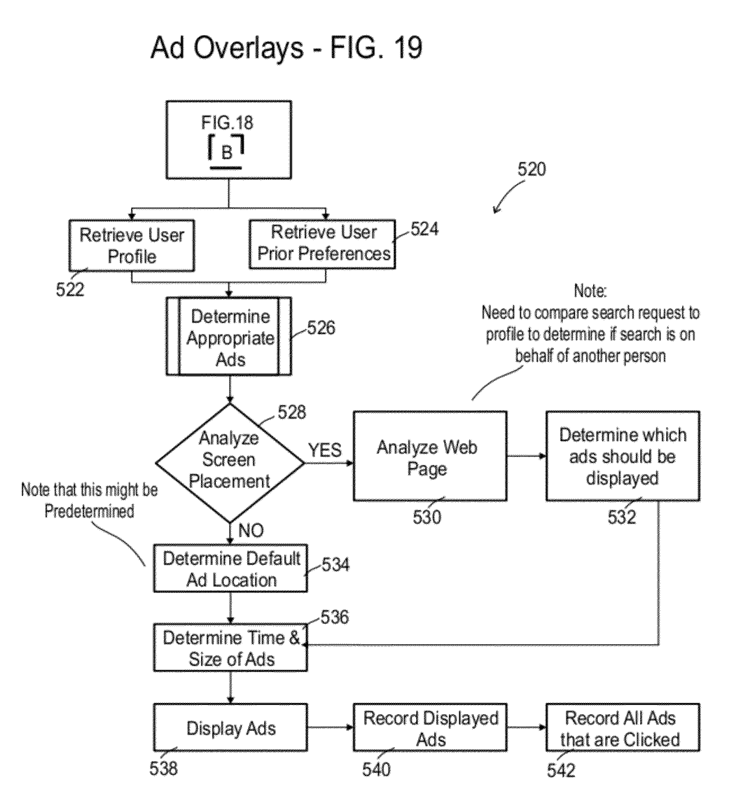

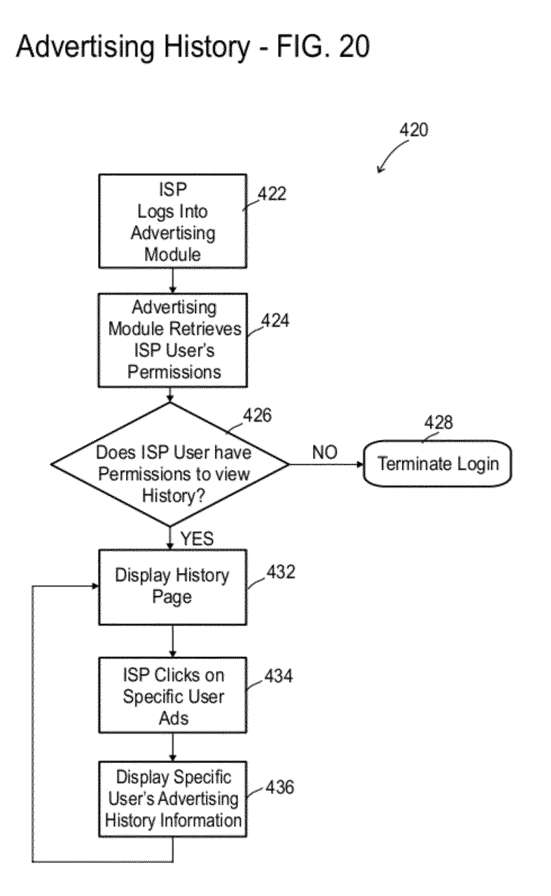

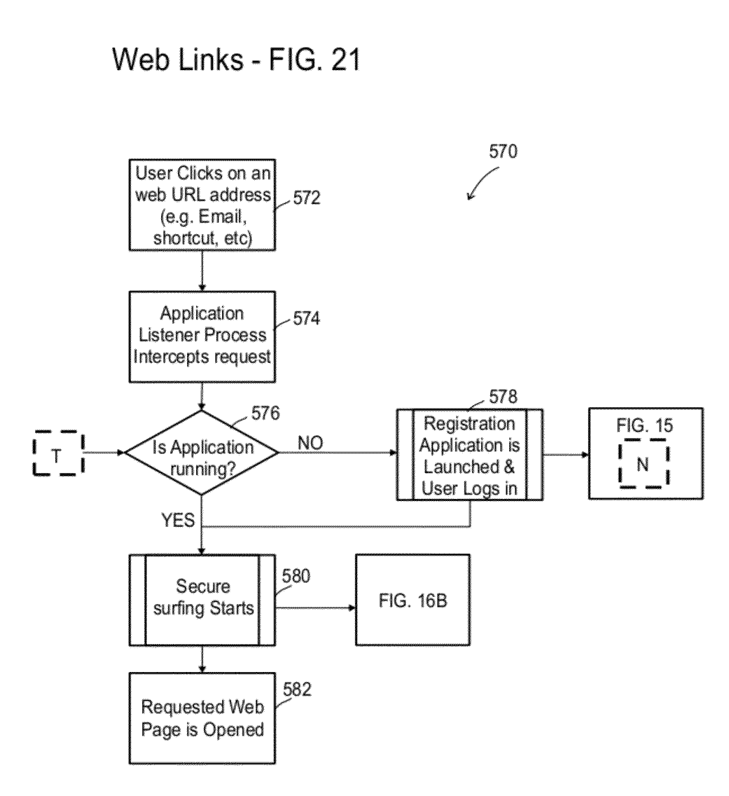

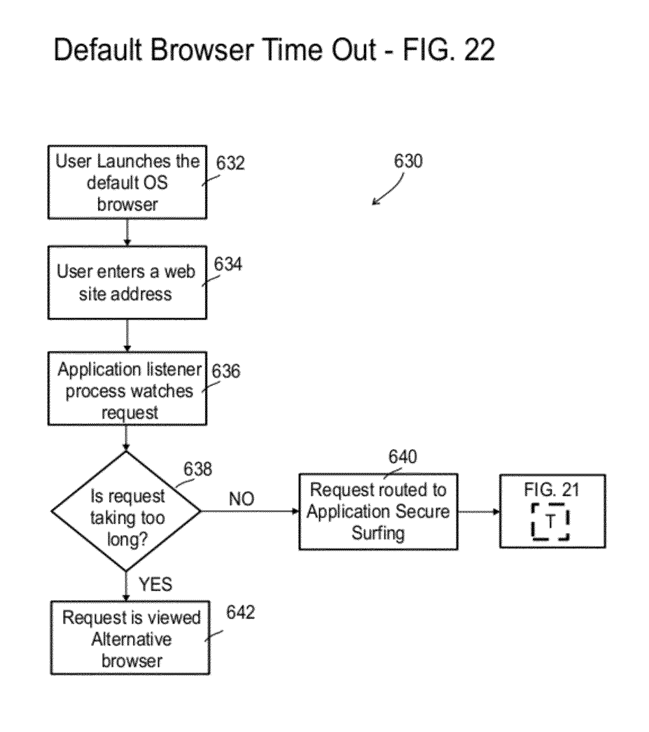

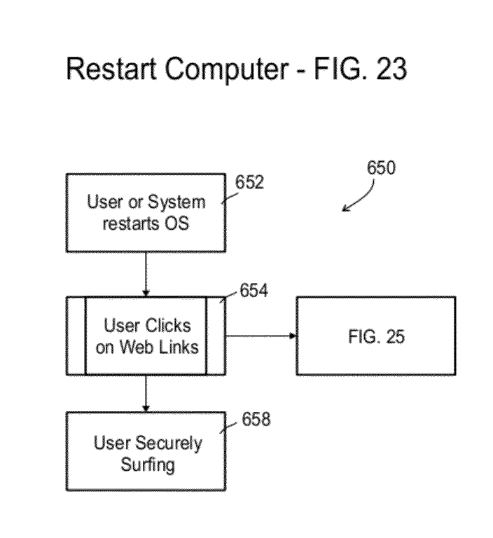

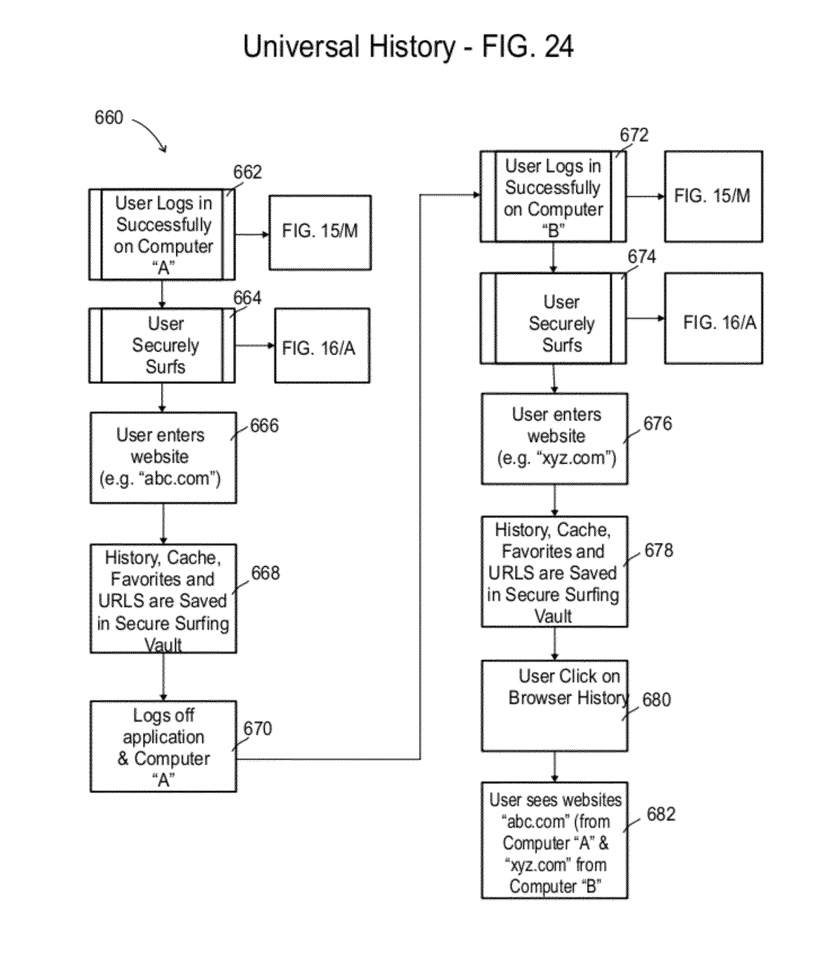

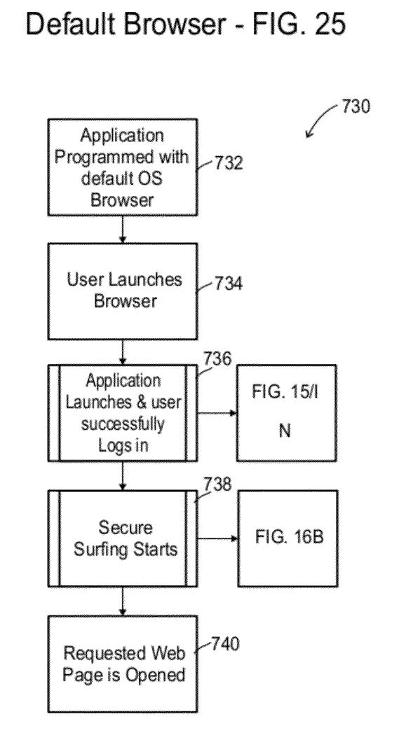

FIG. 15, in accordance with embodiments of the invention;

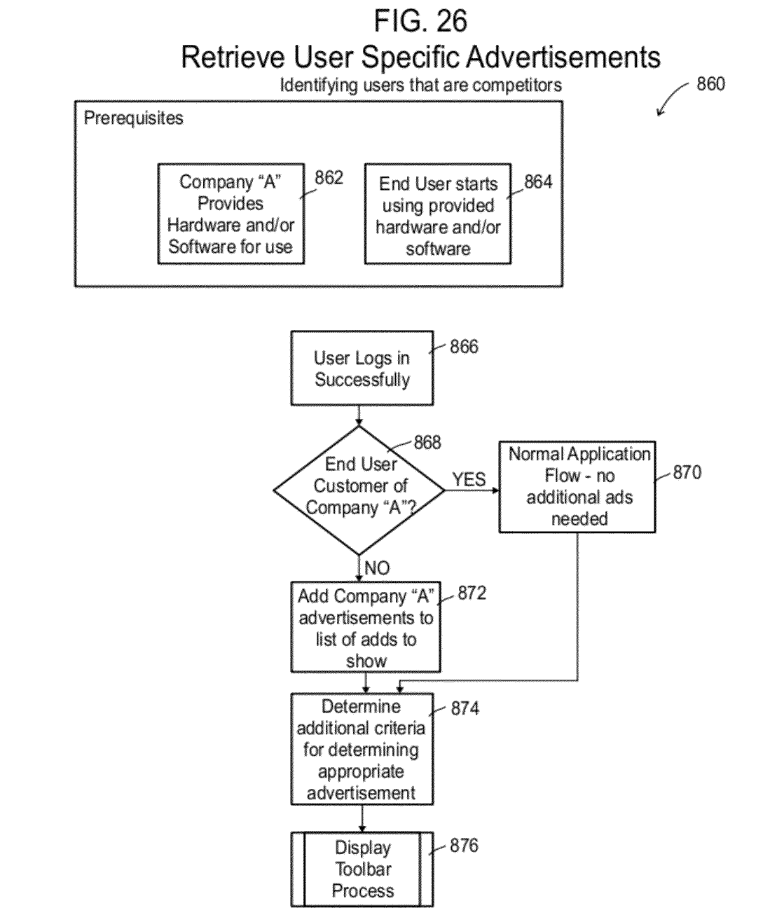

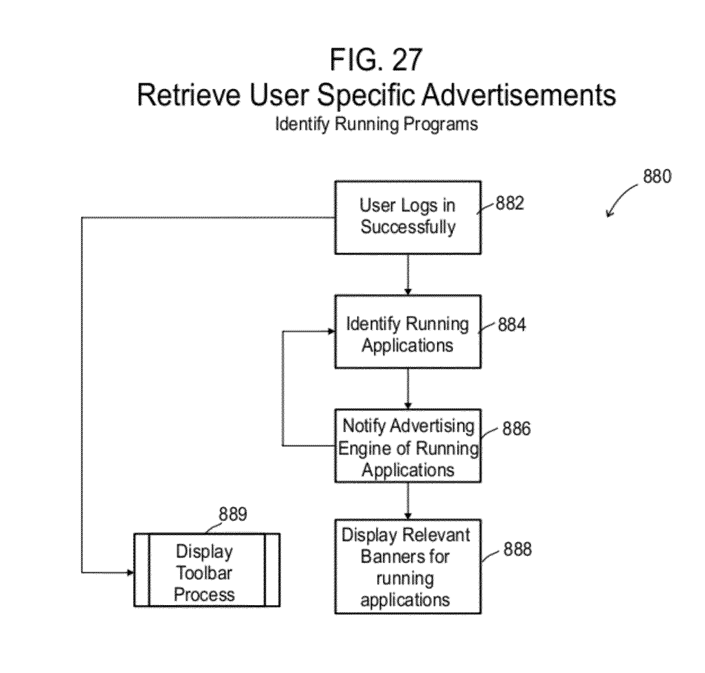

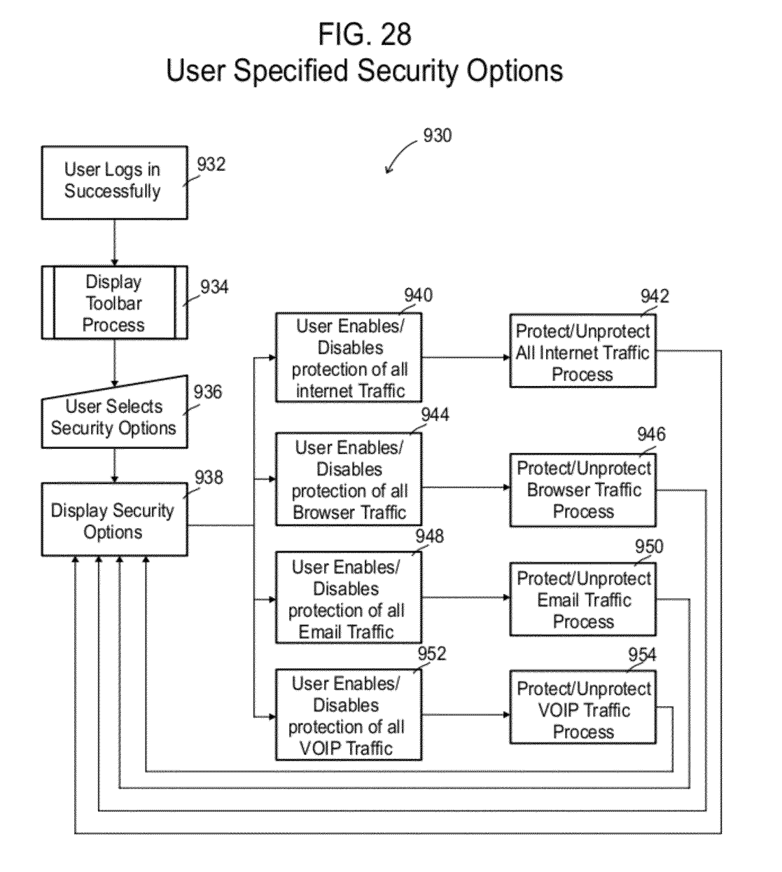

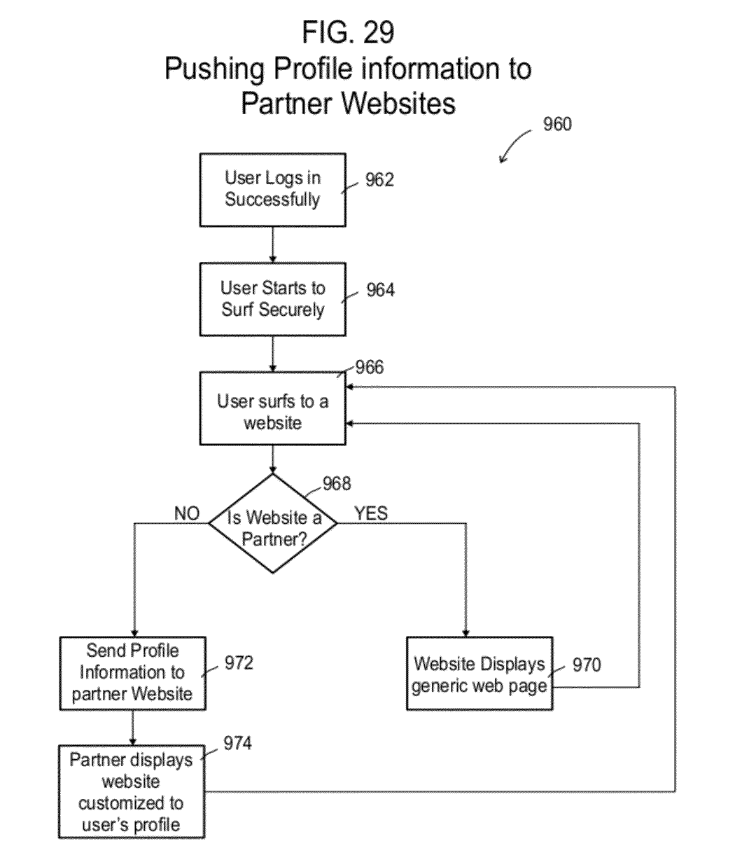

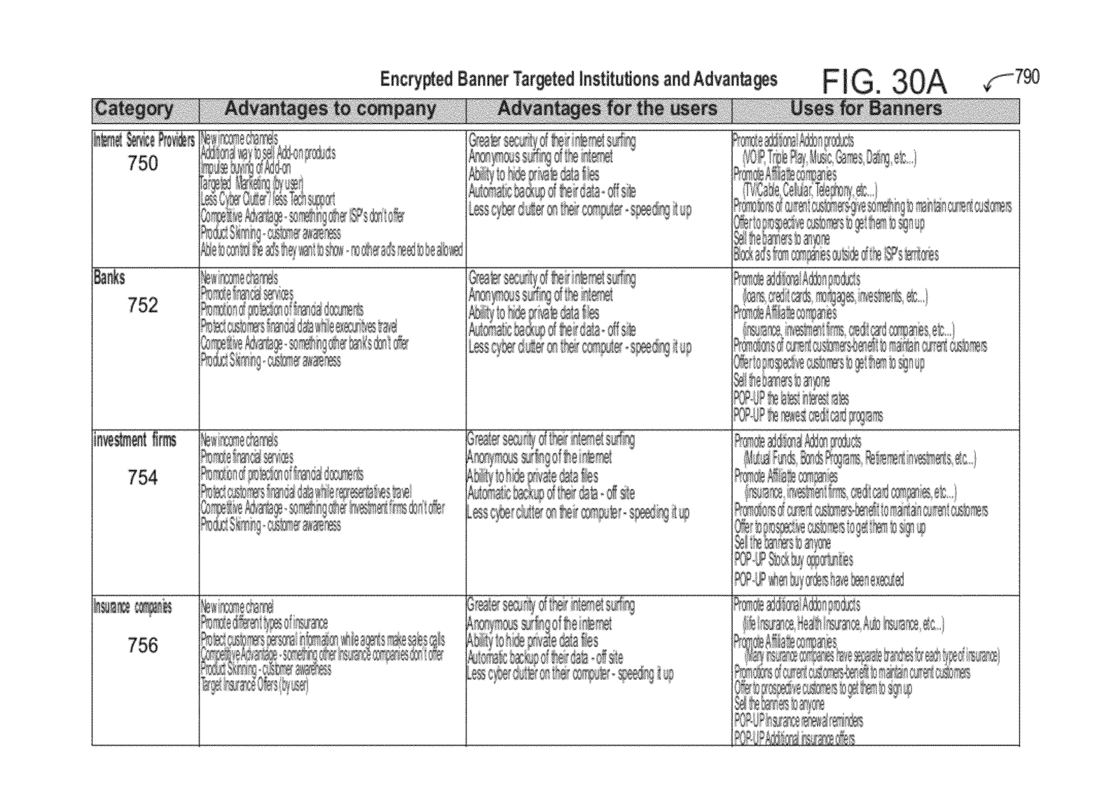

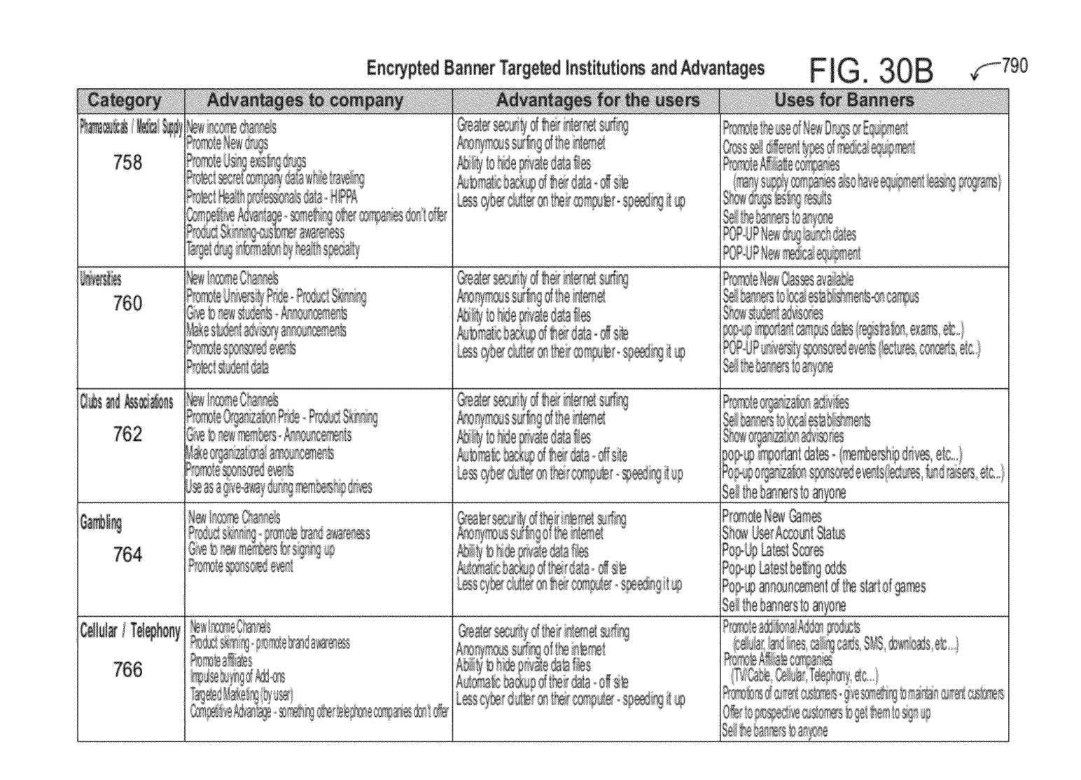

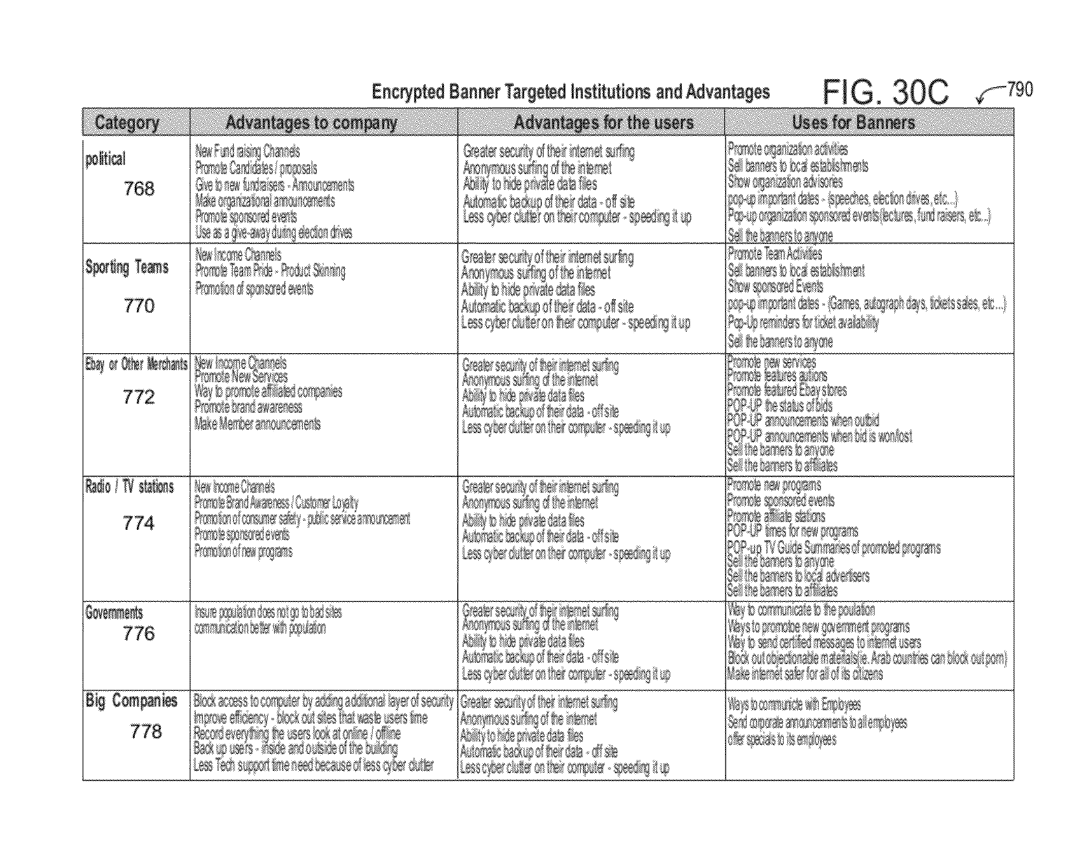

FIG. 16B shows a Secure Surfing flowchart which continues from FIG. 16A, in accordance with embodiments of the invention;

FIG. 17 shows a Software Registration Process which continues from FIG. 2, in accordance with embodiments of the invention;

FIG. 18 shows a Keyword Tracking chart which continues from FIG. 16A, in accordance with embodiments of the invention;

FIG. 19 is an Ad Overlay flowchart, in accordance with embodiments of the invention;

FIG. 20 shows an Advertising History flowchart, in accordance with embodiments of the invention;

FIG. 21 shows a Web Links flowchart, in accordance with embodiments of the invention;

FIG. 22 shows a Default Browser Time Out flowchart, in accordance with embodiments of the invention;

FIG. 23 shows a Restart Computer flowchart, in accordance with embodiments of the invention;

FIG. 24 shows a Universal History flowchart, in accordance with embodiments of the invention;

FIG. 25 shows a Default Browser flowchart, in accordance with embodiments of the invention;

FIG. 26 shows a Retrieve User Specific Advertisements flowchart, in accordance with embodiments of the invention;

FIG. 27 shows a Retrieve User Specific Advertisements flowchart, in accordance with embodiments of the invention;

FIG. 28 shows a User Specified Security Options flowchart, in accordance with embodiments of the invention;

FIG. 29 shows a Pushing Profile Information to Partner Websites flowchart, in accordance with embodiments of the invention; and

FIG. 30A, FIG. 30B and FIG. 30C are three figures showing different applications of the present embodiments.

### DESCRIPTION OF SPECIFIC EMBODIMENTS OF THE INVENTION

The present invention, in some embodiments thereof, relates to network-distributed advertising that download to network computers and, more particularly, but not exclusively, to advertising tags, alternatively referred to as advertising banners, that are overlaid on predetermined areas of network computers.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

Referring now to the drawings:

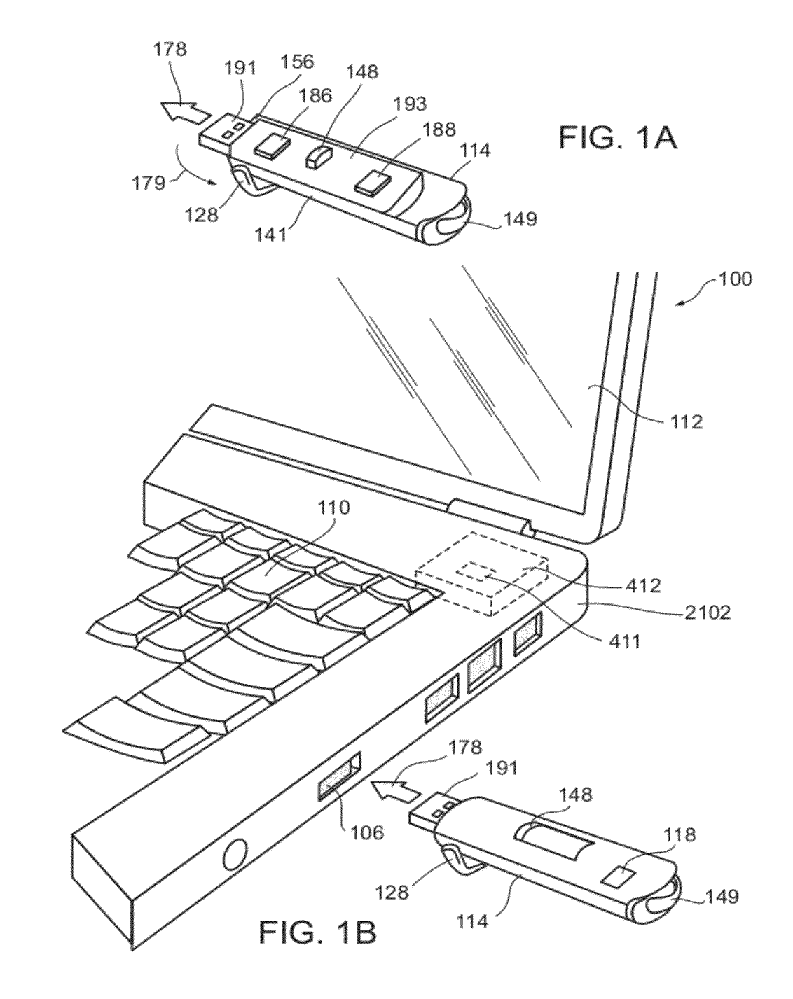

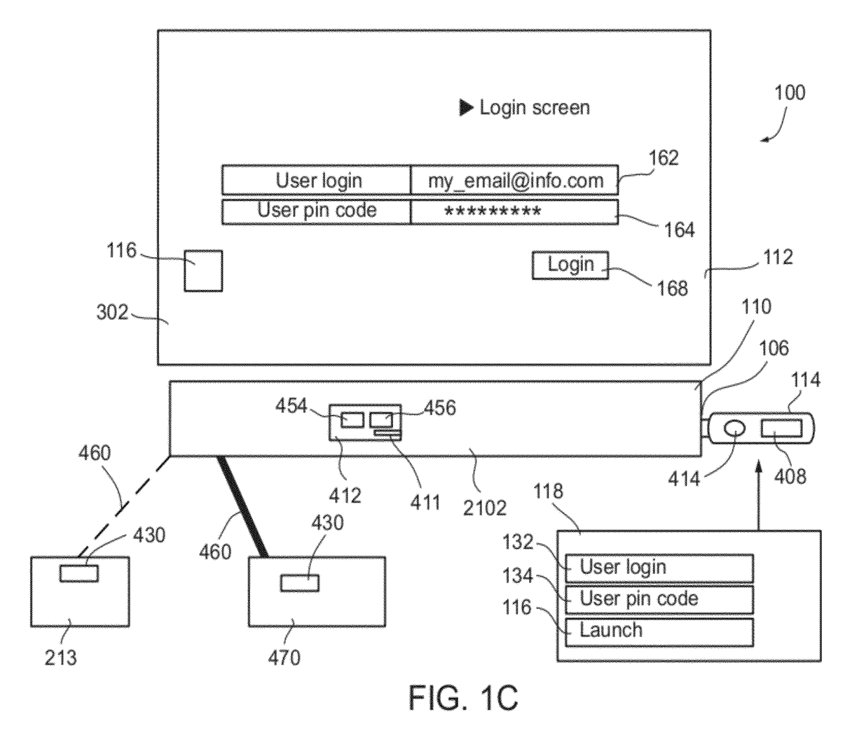

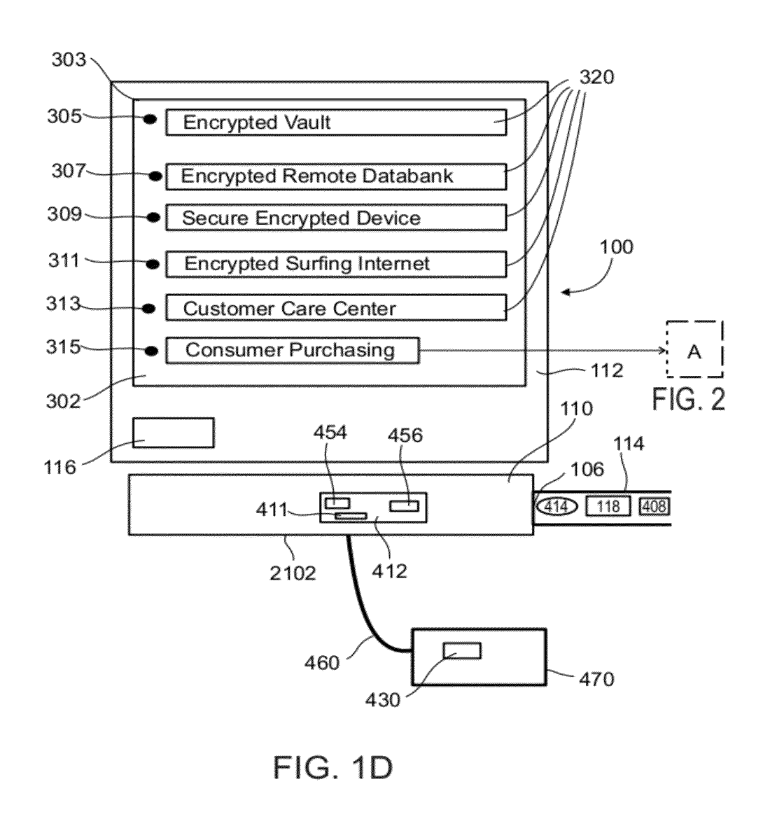

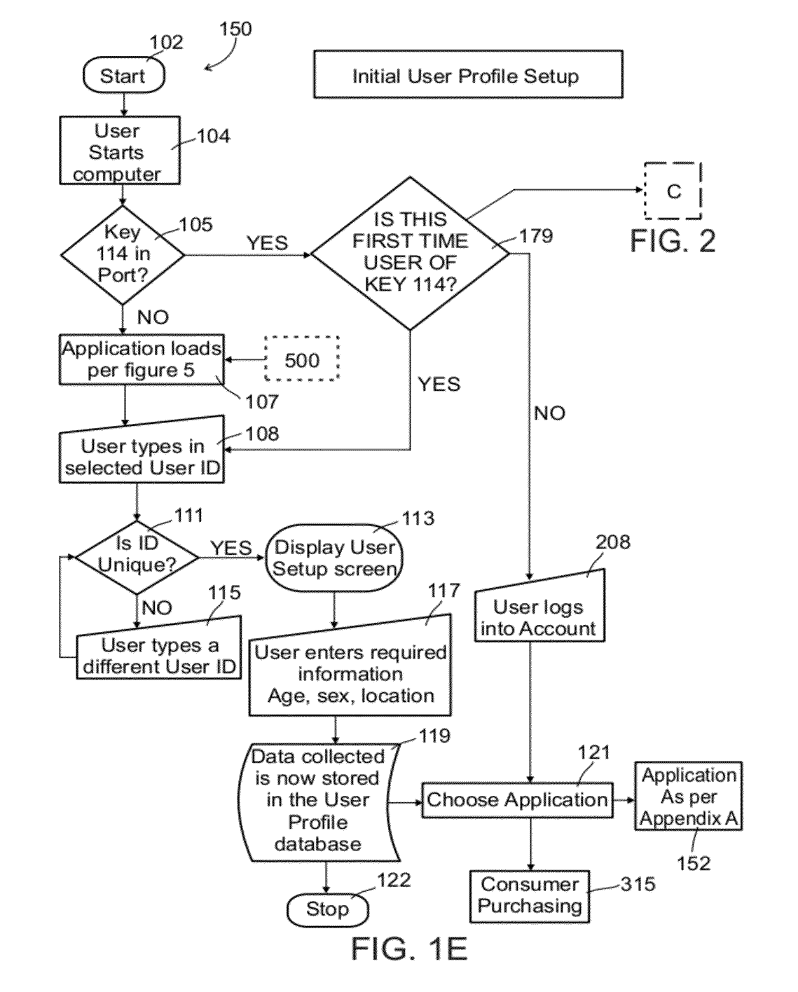

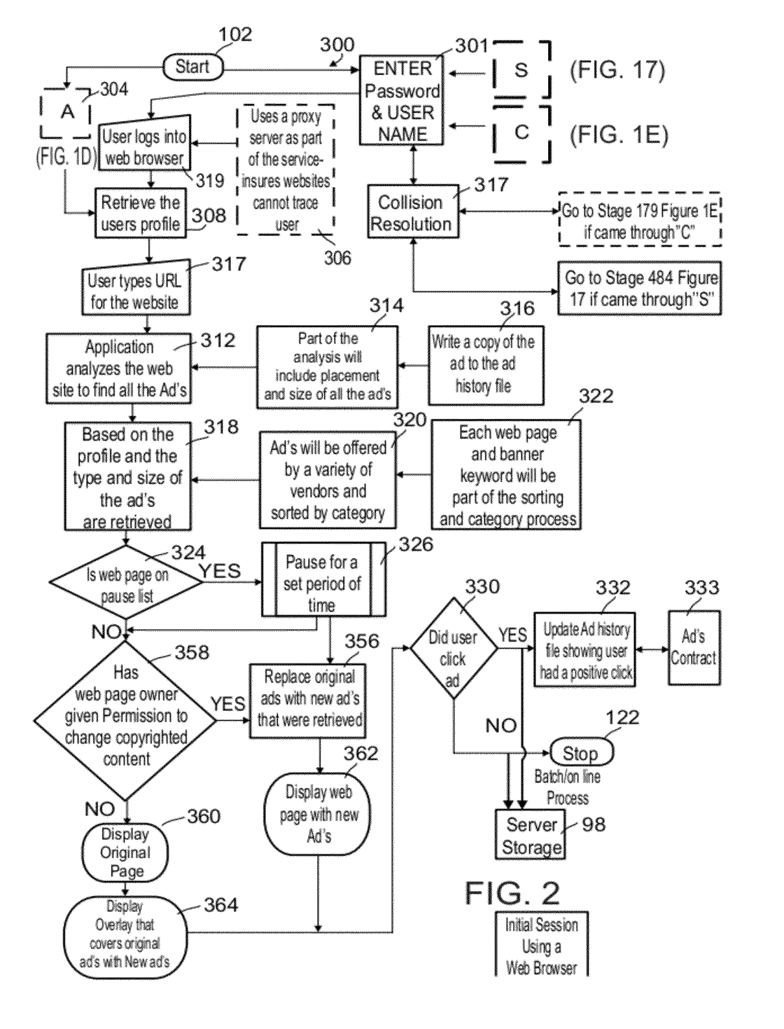

FIG. 1A shows an embodiment of a portable session management device 114 of the present invention, alternatively referred to herein as USB session management key 114 and/or USB key 114.

### Portable Session Management Device Overview

Portable session management device 114 typically has a key ring connector 149 configured to hang on a key chain and a swivel cover 128 that, when in a forward position covers and protects a USB connector 191. With cover 128 in the downward position, a slide button 148 is pushed forward in a direction 178, for example with a thumb movement, thereby bringing USB connector 191 forward to a connection-ready position.

A portable session management device body 193 is connected to USB connector 191 and typically comprises, inter alia, a controller 186 and a flash memory 188.

In non-limiting embodiments, portable session management device 114 comprises a USB key manufactured by Acer®; the many options and manufacturers of portable session management devices 114 being well-known to those familiar with the art.

In non-limiting embodiments, the instant invention presents a portable session management device comprising a user USB device interface comprising portable session management device 114 optionally using a flash memory and/or USB protocol. However, USB is only one of the many user interfaces and protocols that may be used with computer 2102, computing device, and/or any computer memory device. The scope of the present invention includes a priori, all available user interfaces, memory devices and protocols available today or in the future.

FIG. 1b shows a computer 100 comprising a laptop computer 2102 having a keyboard 110, a screen 112, a memory storage 412, for example a hard drive, and portable session management device 114 about to be inserted into a USB port 106. In embodiments, computer 2102 comprises, for example, a Lenovo ThinkPad laptop or any portable and/or non-portable computing device available today or in the future.

In embodiments, session management device 114 includes an authentication unit 118, alternatively referred to as user access module 118, which obtains authentication that user portable session management device 114 is registered with host computer 2102. Upon the authentication of the user, portable session management device 114 provides safe access to computer-based applications in conjunction with host computer 2102.

As used herein, a “computer-based application” comprises, inter alia, use of any type of computing device to: execute and/or use any software program, transfer data between computing devices, encrypt data, backup data, provide safe surfing of the Internet, and/or authorize digital payment of funds. Further, as used herein, a “computer-based application” includes transfer of data via a wide area network, an Internet channel, a server and/or a proxy server.

As used herein, the term “safe”, with respect to accessing a computer-based application refers to substantially preventing access by, inter alia, Internet scams, spyware, spying, junk mail, computer viruses, and/or access by unauthorized users on computer 2102, session management device 114, or any alternative computing device or computer memory device wherein session management device 114 has been authenticated.

While the input of computer 2102 comprises USB port 106, the input could alternatively comprise a serial port, an infrared reception input, wireless communication port and/or any communication means existing today or in the future that facilitates communication between a so-configured portable session management device 114 and a computing means.

### Device Login

FIG. 1c shows a schematic diagram of portable session management device 114 plugged into computer 2102. User access module 118 includes a user device login module 132, alternatively referred to a name module 132 that records a user login name; and a user device password code module 134, alternatively referred to as a password module 134 that records a user password.

User device login name module 132 and user device password code module 134 are encoded into user access module 118 during an initial set-up of portable session management device 114 as explained below.

Additionally, portable session management device 114 includes a unique device identifier 414 that is encoded into portable session management device 114 by the manufacturer as a resident digital string 454. Resident digital string 454, optionally together with the user login name and user password, is transferred to memory storage 412 during set-up of portable session management device 114. In embodiments, portable session management device unique device identifier 414 comprises a string of numbers and digits, whether encrypted or not.

Upon connection of portable session management device 114 to USB port 106, user access module 118 compares unique device identifier 414 with a resident digital string 454 on memory storage 412, thereby preventing access to computer 2102 by another portable session management device 114 that has not been registered with computer 2102.

Upon successful matchup between resident digital string 454 and unique device identifier 414, user access module 118 launches a display 302 (FIG. 1d) on computer screen 112, via a launcher module 116, that requests input of a display login name 162 and input of a display password code 164.

Following input of display login name 162 and display code 164, access module 118 compares display login name 162 with portable session management device user login name 132; and display password code 164 with portable session management device user password code 134.

Following successful matching, the user is prompted to press a “Login” button 168, thereby successfully logging into computer 2102. Upon login, user access module 118 signals launcher module 116 to open a window 302 on screen 112, as seen in FIG. 1d.

In alternative embodiments, access module 118 associates with the auto run feature of Windows XP operating system by Microsoft Corporation to provide display 302. In alternative embodiments, as explained below regarding FIG. 17, the user can access display 302 without using portable session management device 114.

In accordance with the embodiments of the present invention, once the user has been authenticated through the identification of the display login name 162 and display password code 164, any encryption or decryption process associated with the portable session management device 114 stores a hash value 456 along with each data packet, as explained below.

As used herein, the term “hash” refers to the creation of an encryption code associated with a portion of digital data.

As used herein, the terms “encrypt” and “encryption” refer to the coding of at least a portion of data, using at least one algorithm so as to prevent unauthorized inspection of the data. In further embodiments, inspection of the data is facilitated by an unencryption code comprising the same algorithm used in the coding of the data.

As used herein, there term “inspection” refers to accessing, reviewing, or determining information from any digital string or data portion stored on a computing device and/or memory storage device.

As used herein, the terms “conceal” and “concealing” refer to any obfuscation, encryption, or coding of data to prevent unauthorized inspection of the data.

As used herein, the terms “authentication” and/or “authenticate”, refer to, inter alia, verifying the integrity of a digital message or portion of data, and/or verifying the identity of a user who accesses a computing device and/or network; the verification including use of any password, biometric parameter, digital certificate, code and/or digital string.

In embodiments of the present invention after generation of hash value 456, the value is encrypted and stored on portable session management device 114, for example in a device memory storage 408.

In embodiments, hash value 456 associated with portable session management device 114 is sent, for example via a secure VPN (virtually private network) connection, to a server 470, for example in a remote location, for storage in a secure encrypted user accessible vault 430.

As used herein, the term “server” refers to any storage device employing magnetic, optical or alternative media, including, inter alia, server 470 located locally and/or a remote server 213 located at a remote location.

As used herein, any reference to connections between computer 2102 and computer storage, for example local server 470 or remote server 213 and/or methods and protocols for connecting therebetween, includes a priori, all available methods, devices and/or protocols available today or in the future. The many options for connection between laptop computer 2102 and servers 470 and 213 are well known to those familiar with the art.

Further, as used herein, the term “computer” 2102 refers to any computing device having a connection to a portable session management device 114 comprising a USB device or any other external device that connects with computer 2102.

Persons skilled in the art will further appreciate that portable session management device 114 is optionally connected to computing devices, for example computer 2102 and/or servers 470 or 213, directly or via various network configurations and/or computer communication protocols currently available or to be later developed.

In embodiments, launcher module 116 comprises a protocol written using the “.Net” platform program marketed by Microsoft Corporation, of Seattle, Wash. Alternatively, launcher module 116 comprises a U3 launching pad manufactured by the U3 Corporation of California, USA.

In alternative embodiments, launcher module 116 comprises one or more software programs, including software modules, software components, software libraries and/or software Dynamic-link libraries (DLLs) that, in turn, include computer instructions for the relevant operations that operate in conjunction with user access module 118 to provide the many services of portable session management device 114, some of which are detailed below.

The software programs operative with user access module 118 are optionally written in accordance with embodiments in the C, C++, C#, Java or other programming languages, and executed in connection with one or more operating systems, including but not limited to, Windows, Linux, or UNIX platforms.

Portable session management device 114 allows the user to securely surf websites on the Internet. In embodiments, following login and opting for secure surfing 310, a specially configured internet browser is launched from the device which stores session information such as cookies and site history in a manner that the information cannot be inspected without the device, as will be further detailed below.

In some embodiments, the data is stored on the device. That is to say, history of each site visited by the user and any downloaded information or communications during a given surfing session are entered into portable session management device 114.

As used herein, the term “history” with respect to management device 114, refers to any record of digital and/or analogue information and/or communications via the Internet, chat rooms, blogs, and/or e-mail.

As seen in FIG. 1d, in a non-limiting embodiment, a window 303 on screen 112 provides the user with the following options via display buttons 321:
Access to a Secure Encrypted Vault 305;
Access to a Remote Storage Databank 307;
Access to a Secure Encrypted Device Memory 309;
Access to a Secure Surfing on the Internet 311;
Access to a Customer Care Center 313; and
Access to Consumer Purchasing 315.

The user selects, for example by toggling, one of the options on window 303, for example “Consumer Purchasing” 315, and screen 112 displays the opening display associated with “Consumer Purchasing” 315 at a stage 304 on a chart 300; shown on FIG. 2, as explained below.

Alternatively, when the user clicks onto “Secure Surfing on the Internet 311”, advertisements are automatically overlaid on specific areas of the resultant Internet display in a manner that preserves the display copyright, as will be explained below.

As used herein, the words toggle, click, choose, select and grammatically related words and/or words having similar connotations, refer to choices that are executed by the user using, inter alia, a keyboard, mouse, touch screen, and/or pen.

Further functions related to portable session management device 114, for example access to options 303, 305, 307, 309, and/or 311, are described in PCT IL2006/001497, Computer Session Management Device and System, filed 27 Dec. 2006 with priority from U.S. Provisional Application 60/753,395, filed 27 Dec. 2005 and Published as WO2007/074458 on 5 Jul. 2007; the content of which is hereby incorporated in its entirety into the present application by reference.

FIG. 1e shows a simplified illustration of the overview of the flow of a new user registration process 150, with and without portable session management device 114.

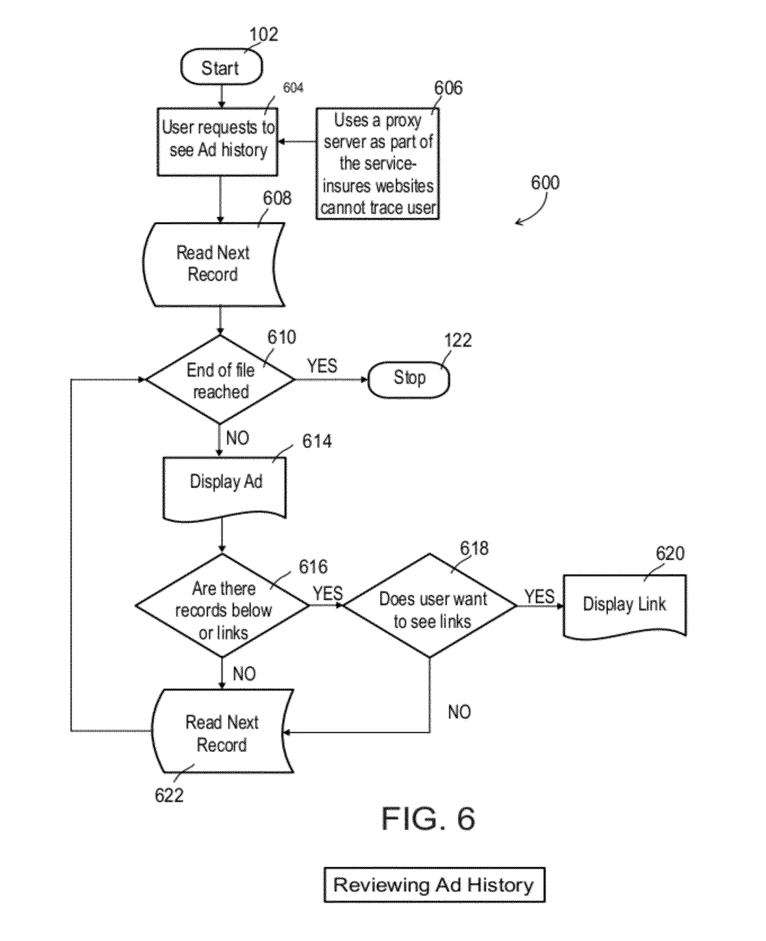

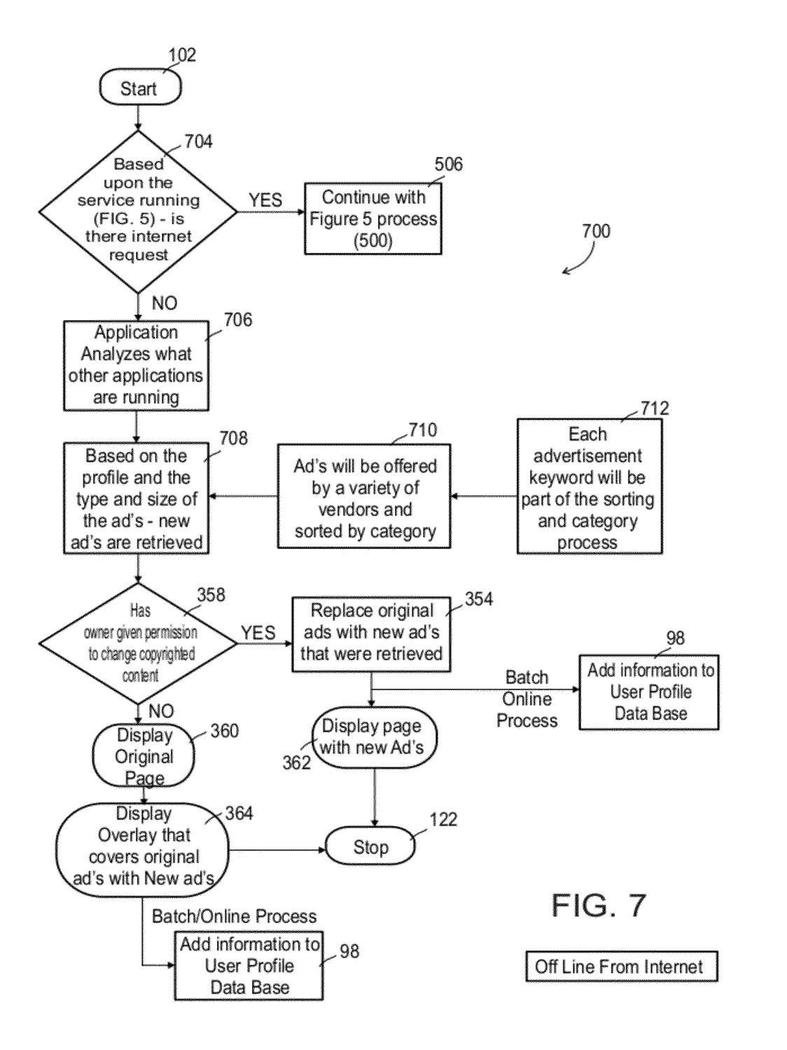

The process begins at a start stage 102 in which the user starts the computer at a stage 104. The computer determines if there is a portable session management device 114 in the port of the computer at a stage 105. If no portable session management device 114 is present at stage 105, an application, for example related to a flowchart 500 (FIG. 5), described below, loads on the computer.

The user then proceeds to a stage 108 in which the user types in a user-selected ID.

Alternatively, at stage 105 if the computer determines that there is a portable session management device 114 in the port of the computer, at a stage 179, the computer communicates with portable session management device 114. If this is the first time portable session management device 114 is being used, the user proceeds to stage 108, noted above, and types in a selected User ID.

At a stage 111, the ID provided by the user either directly into the computer or via portable session management device 114 is analyzed to determine if the ID is Unique.

If the ID is not unique, the user proceeds to a stage 115 in which a different ID is provided by the user.

Once the uniqueness of the user ID is established, the user is provided with a Setup screen at a stage 113. The user is then prompted at a stage 117 to provide parameters, for example age, sex, location and income level that will aid in providing the user with the most relevant advertisements.

At a stage 119, the user parameters are stored in the user profile database, for example on portable session management device 114 and/or on a proxy server as explained below.

At a stage 121, the user is prompted to choose an application, for example consumer purchasing 315.

Alternatively, the consumer may choose, at a stage 152, any application shown in the chart shown in FIG. 30.

Alternatively, when the user accesses the computer with portable session management device 114, logs into his or her account at a stage 208 and proceeds to choose an application at a stage 121, as noted above.

The present invention is not limited to safe surfing using portable session management device 114; but may be activated and utilized by using software protocol provided, for example, by an ISP. The following description describes just one of the many software-based protocols that can be implemented.

### Software Registration

FIG. 17 shows an alternative Registration Process Flow flowchart 480 using software provided by, inter alia, an Internet Service Provider, or a Web Browser.

In some embodiments, the user purchases a software package, for example a CD program, and at a launch registration stage 482, the user inputs a product key and personal identification pin supplied by the software vendor. In further embodiments, the user launches a software package embedded in the Internet browser, for example Internet Explorer (IE) and inputs a product key and personal identification pin supplied by the software vendor via e-mail.

In still further embodiments, the product key and/or personal identification pin are sent via a secure VPN connection to the server for storage in a secure encrypted user accessible vault.

The many methods for providing software and product keys are well known to those familiar with the art.

Upon successful entry of the product key, at a stage 484, the user enters account and contact information and the product pin, alternatively referred to as a user password. At a stage 486, the software checks for any registration errors and at a stage 486, the software downloads onto the server, whether local or remote, a unique identifier that is encoded into the server; while at a stage 488, user details are saved, for example in a secure vault on the server.

At a stage 490, Terms and Conditions of use of the software are displayed and following acceptance of the same at a stage 492, the user inputs a pin at a stage 494 and the user identity is confirmed.

In addition, at a stage 496, the user selects Secret Hint & Answer to enable, inter alia, communication with the software vendor in the event that the user forgets the pin. At a stage 498, the ISP is contacted electronically and an account is created at the ISP, following which the user accesses a stage 499 Display Toolbar Process.

Following display of the toolbar, whether the user registered using a portable session management device or a software-based protocol, the user can now receive advertisement banners on the host computer.

### Advertisement Access

FIG. 2 shows flow chart 300 illustrating the process by which a previously-registered user receives advertisements on the computer display.

In some embodiments, at stage 304 the user logs directly into “Consumer Purchasing” 315, represented by box “A”.

In alternative embodiments of the invention, an alternative registration process occurs at a stage 319 and includes automatic initiation of secure surfing on the Internet 311 (FIG. 1d) in which the user is provided with safe access to all user-initiated functions and displays on the host computer. Safe access includes, inter alia, encrypting and decrypting data and safe backup of all network surfing and/or data input by the user; as described in above-noted PCT IL2006/001497, “Computer Session Management Device and System”.

In some situations, prior to stage 319, at a stage 301 in which the user enters a name and password, whether as a first time user or a repeat user, there may be a collision between sponsors of one or more portable session management devices 114 (FIG. 1d) and/or user software-based profiles (FIG. 17).

For example, if the user initially set up a first profile that is sponsored by America On Line (AOL), the host computer may be prohibited from setting up a second profile sponsored by the enterprise company and/or another ISP, for example MSN (Microsoft Network).

As will be explained below, in some embodiments of the invention, the user is provided with an option to switch between ISPs while maintaining user advertising history.

Referring to FIG. 2, at a collision resolution stage 317, a software module resolves the conflict between the portable management devices. Collision resolution can also occur at a stage 179 in FIG. 1e, which refers to a stage 301 in FIG. 2.

In some embodiments, a stage 306 is automatically accessed wherein a proxy server provides an interface between the user computer and websites in a manner that the user history, and/or even singular web sites accessed by the user, cannot be traced by any party.

Alternatively, the proxy server provides an interface that allows tracing of user history by a program and/or designated internal company officials associated with the present invention as will be explained below.

As used herein a proxy server refers to a server that receives requests intended for another server and that acts on the behalf of the client, as the proxy, to obtain the requested service. A proxy server is optionally a gateway server that separates an enterprise network from an outside network, protecting the enterprise network from outside intrusion.

At a stage 308, the user profile is retrieved and at a stage 317, the user types the Uniform Resource Locator (URL). As used herein URL refers to identification of network-retrievable documents. Such documents may be located on the worldwide website (WWW), a local network comprising a data display that is administered by an employer for employees, for example a company-based webmaster who oversees a company-based web, or a group website that is shared by users having one or more common interests.

At a stage 312, the application analyzes the data display to find all the advertisements, pop-ups, and/or spaces that can be overlaid.

In embodiments, advertisements from a variety of search engines are accepted by the banner program; search engines including, for example AOL, MSN, a search engine associated with the enterprise company and/or the system or portable management device distributor.

Additionally, the banner program analyzes the advertisements to determine that the advertisements are appropriate to the parameters of the client. For example a user who is aged 10 and male, would only receive advertisements for shoes that are for male users that are of a size range that is appropriate to a ten-year old.

Optionally, the advertisements are analyzed by the banner program, proxy server and/or any other management system associated with the advertising to determine that the graphics, content, links and/or text associated the banner are appropriate for the targeted audience. For example the advertising to the 10 year old male would not include sexual content designed to promote the product.

In embodiments, the banner program includes analytic capacities to determine that the advertisements are not against moral and/or ethic standards. For example, ads that inter alia promote and/or are linked to suicide, terrorism, drugs, and/or pedophilia would be filtered and/or the originating advertiser would be banned from the banner system.

Alternatively, the parameters of the user are part of a banner program analysis module and the parameters are formulated in a query to the various search engines along with the products requested. The search engines then transmit parameter-appropriate advertisements, for example shoes for 10 year old males, noted above.

At a stage 314, part of the analysis includes placement and size of all the available data display for advertisement overlay.

Additionally, at a stage 316, a copy of the advertisement is written on the user history, such that the history can be used as a basis for initiating further advertisements that will be of interest to the user.

At a stage 318, based upon the type and size of the area to be overlaid, alternative advertisements are retrieved.

In embodiments, the overlaid advertisements are from a variety of vendors at a stage 320. Additionally, the overlaid advertisements may be ordered to pop-up based upon alphabetical listing of vendors and/or category of interest to the user.

Additional display parameters, for example the period of time that an advertisement banner is overlaid over another advertisement, will be explained below.

At a stage 322, each page and/or banner keyword displayed on the data display of the user is included in the sorting and category process.

At a stage 324, the web page and/or data display of the user is analyzed to determine eligibility for pausing the computer display and entering an advertising overleaf on the computer display and, if so, at a stage 326 a pause will be set into the user display that will determine the period of time that the advertising overlay will be displayed.

At stage 358, if the user data display allows overwriting, the advertising overlay is analyzed at a stage 356 to determine where the overlay will be embedded in the user data display for the period of time determined in stage 326. At a stage 362, the advertising overlay is embedded into the user display.

In some embodiments, advertisements are overlaid on the display when the user accesses a company website and/or, inter alia, on programs, documents or spreadsheets displayed on the user computer.

If, at 358, the user data display prohibits overwriting, the original user display is maintained at a stage 360 and, at a stage 364, the advertising overlay is overlaid on a designated portion of the user display, for example over a pop-up and/or a graphic box.

As used herein, the term “data display” means information that is displayed on the user computer that includes, inter alia, at least one of:

i) a web browser;

ii) a company-based network display, alternatively referred to herein as an “enterprise network”;

iii) a personal computer-based program;

iv) an e-mail;

v) a chat room;

vi) an instant message;

vii) a blog;

viii) a pop-up advertisement; and

ix) any data that is overlaid on a user screen display.

Further, as used herein, “data display”, additionally includes at least one area of the user screen including, inter alia, at least one of:

i) text;

ii) a spread sheet;

iii) a graphic interface;

iv) a figure;

v) a picture file;

vi) an animated presentation;

vii) a video file;

viii) a text box; and

ix) a banner.

The advertising overlay is displayed and, in embodiments, includes prompts for the user to enter linked data related to the advertising overlay.

For example, the advertising overlay announces a special rate on life insurance for people of a certain age, including the age of the user.

The user is invited to click on a portion of the advertising overlay in order to enter a second advertising overlay that provides details of the special life insurance. The second advertising overlay may additionally include an area to click for entering a third overlay providing a copy of a sample insurance policy and/or a sign-up sheet whereby the user registers for the life insurance policy.

At a stage 330, the response of the user in terms of clicks on the advertising overlay are recorded and at a stage 332, the file history of the user is updated to reflect the number of clicks that indicate user interest in the advertising overlay.

In the future, the history recorded at stage 332 will be used to provide the user with additional overlays that relate, for example, to life insurance; for example health care packages and/or auto insurance.

If, however, the user did not click on the advertising sign overlay, the lack of response is not updated in the file history.

Whether clicks were or were not initiated, at a server storage stage 98, the user history is stored on a server associated with the advertising overlay administration.

In embodiments, the entire surfing record is concealed and/or encrypted either within the computer, on the proxy server, or on the portable session management device; thereby retaining the record virtually invisibly, so that all records are inaccessible to, inter alia, unauthorized users of the computer or portable device, or advertisers or hackers that attempt to enter the computer via the Internet or Intranet.

As used herein, Intranet refers to a local area network, for example within the enterprise company or two or more host computers that are interconnected locally or through any VPN. In some embodiments, an advertiser may wish to advertise on a limited basis, for example, paying for 1000 user entries, comprising click streams into a given product or product category. In such cases, the advertising history, stored on the proxy server, portable management devices and/or in the host computer data storage, is tallied by an advertising contract module at a stage 333.

The advertising contract module maintains records of the number of “hits” by the user and automatically suspends advertising upon reaching the specified number of hits.

In embodiments, the advertiser has an option to access a website associated with the banner software system and may additionally access a menu that allows the user to specify the limitations on the advertising campaign; for example the number of user connections including, inter alia, the number of user inquiries, purchases and/or hits into the product category.

Additionally, the menu can be programmed to provide the advertiser with a series of options and associated prices by which the advertiser limits the advertising campaign. For example, if the advertiser specifies that the product inventory is a maximum of 1000 units, or that the promotion of a given product will last a maximum of one week, the software will provide an appropriate price for this period of time.

Optionally, the software bases the appropriate price on both the number of hits, time the promotion lasts, and the cost of the products.

In embodiments, the advertising menu offers the user the ability to organize the structure of the campaign. For example, if the advertiser spreads the products over five separate websites, and the advertiser wishes to pay for a maximum of 100,000 user inquiries, the advertiser can limit each of the five websites to a maximum of 20,000 inquiries each. After a given website records 20,000 inquires, the given website is restricted from further display of the products and the user may now access only the remaining four websites that advertise the product.

The manner of structuring advertising, for example through multiple websites, multiple products and/or multiple product categories and/or a menu-generating software by which such advertising campaigns are structured, is well-known to those familiar with the art.

The many institutions that can benefit from structured advertising Banner Overlays and the many advantages that each of many institutions may enjoy can be appreciated by viewing chart 790 shown in FIG. 30. The represented institutions include:
750 Internet Service Providers;
752 Banks;
754 Investment Firms;
756 Insurance Companies;
758 Pharmaceutical and Medical Supply Houses;
760 Universities;
762 Clubs and Associations;
764 Gaming and Gambling Parlors;
766 Cellular Telephone Companies;
768 Sport Teams;
770 Political Organizations;
772 Ebay and other Internet Purchasing Web Sites;
774 Radio and Television Stations;
776 Government Institutions; and
778 Large Companies.

### Growing a User Profile

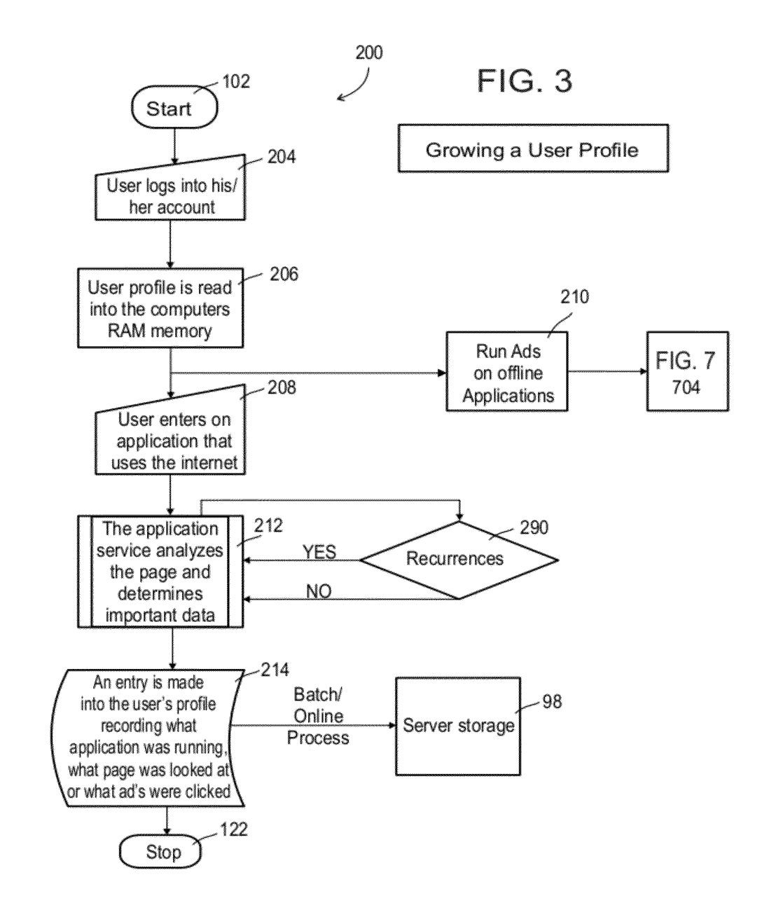

FIG. 3 shows a “growing a user profile flow chart 200 in which the user logs into a personal account at a stage 204 and the user profile, including information and/or parameters entered at stage 117 (FIG. 1e) is read into the computers RAM memory at a stage 206.

At a stage 210, the user may optionally choose to receive advertisements from off-line applications as presented in a chart 700 (FIG. 7), as will be explained below.

At stage 208, the user enters an application that uses the Internet and at a stage 214, an entry is made into the user profile; a recording of the application running, the page and/or advertisements displayed and/or user interest as indicated by which advertisements were clicked. At server storage stage 98, the information in the user profile is downloaded, for example using a batch and/or online process and stored in the server.

In some sessions, the user may initially view a first product, for example a cooking pot, at a low price. The user may then click on a second product comprising a cooking pot at a higher price and then return to the first product at the lower price; with the back-and-forth clicking by the user providing valuable information on the user price preferences even if the product is not purchased.

To record the back-and-forth clicking, at a recurrences stage 290, if the user has accessed a given page, for example the first product, multiple times, either in a single session or in multiple sessions, the recurrences are also analyzed at a stage 212 and entered into the user profile.

At a stage 122, thereafter, the user stops the application and proceeds to another computer-resident application, an alternative Internet application, or exits all applications and, optionally, shuts down the computer.

In some Internet sites, advertisements are presented in non-streaming web data; and just one example of how the present invention overlays advertising in such environments is now presented.

### Advertising Overlay Process

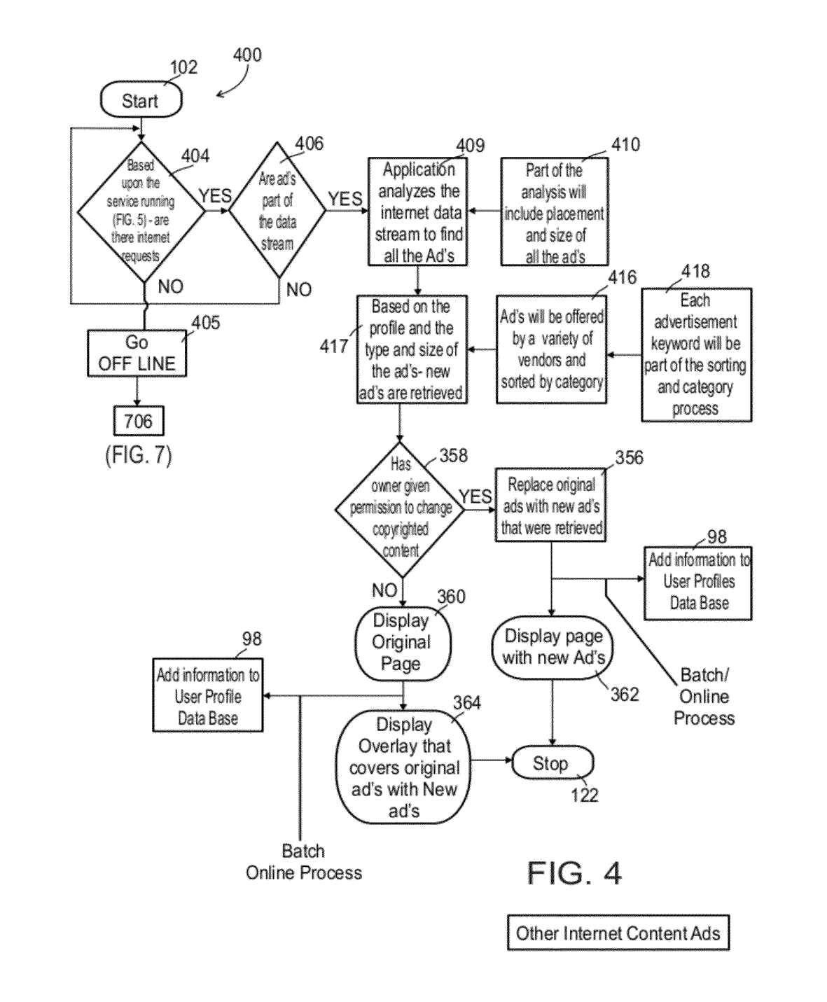

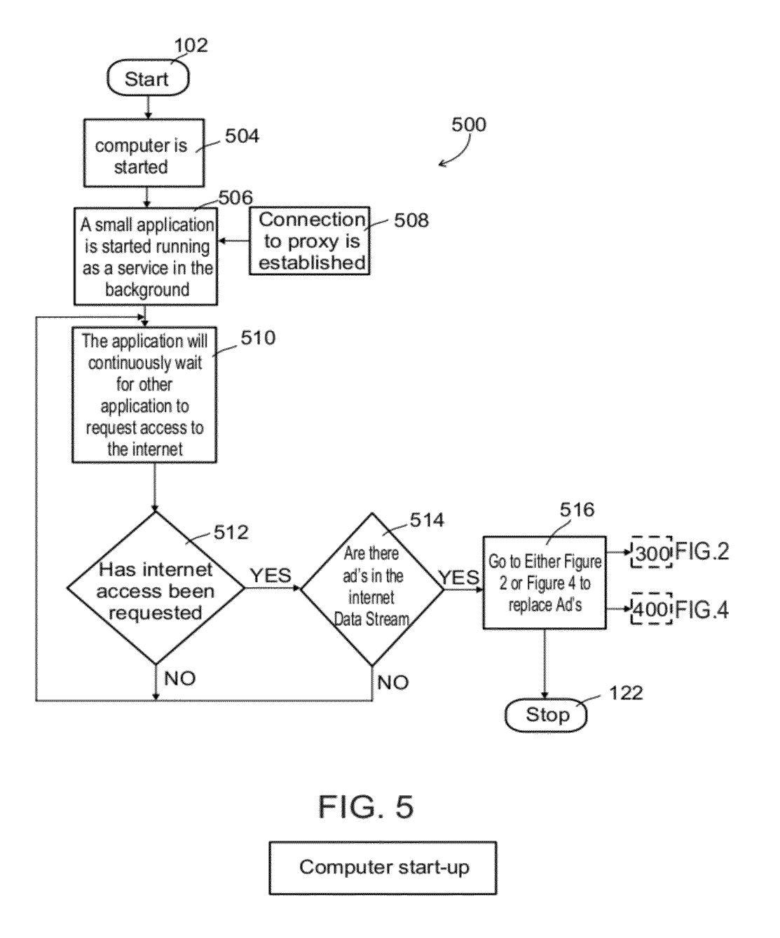

FIG. 4 shows a simplified flow chart 400 illustrating how the present invention will overlay advertisements in non-streaming web application data, in accordance with embodiments of the invention.

Following entrance into a web site, at a stage 404, with a web running service, for example a service related to flow chart 500 (FIG. 5), the program determines if there are internet requests.

At a stage 405, if there are no internet requests, the advertising overlay program will go off line and proceed to box 706 of FIG. 7, as will be explained below.

If there are advertisements, at a stage 406, the program determines if the advertisements are part of the data stream.

If the advertisements are part of a data stream, at an application stage 409 the internet data stream is analyzed to find all the advertisements.

At a stage 410 part of the analysis includes placement and size of all the advertisements. At a stage 417, new advertisements are retrieved based on the user profile and the type and size of the advertisements.

Note that system uses a proxy server, noted above, as part of the service so the user is insured that websites and third parties cannot trace user history.

At a stage 416, advertisements are offered by a variety of vendors and sorted by category. At stage 418, each advertisement keyword becomes part of the sorting and category process.

At stage 358, if the user data display allows overwriting, the advertising overlay is at analyzing stage 356 to determine where, for example, the overlay will be embedded in the user data display.

At stage 362, the advertising overlay is embedded into the user display. Alternatively, at stage 364, an advertisement is overlaid on the user data display for the given period of time. Information is then added to the user profile database at stage 98.

### Computer Startup

FIG. 5 shows a computer startup flow chart 500 illustrating a typical start up process beginning at a stage 504 for the user computer in which at a stage 506 a banner application begins running as a service in the background. At a stage 508 the connection to the proxy server is established.

At a stage 510 the application continuously waits for other applications to request access to the internet. At a stage 512 the banner program determines if internet access has been requested; if not, stage 510 is accessed again.

If internet access has been requested, at a stage 514 the banner program determines if there are advertisements in the internet data stream; and returns to stage 510 if not.

If the advertisements are part of the data stream, at a stage 516 flow chart 300 (FIG. 2) or flow chart 400 (FIG. 4) are accessed to replace advertisements.

In embodiments, the present invention allows web masters, ISPs or sponsors of a company enterprise, to review user preferences in advertising so that, for example, preferred product categories can be supplied with additional products. Alternatively, the user may wish to review advertising history to locate certain products.

There are a variety of protocols by which a viewer advertising history can be reviewed by an ISP, with just one such protocol being now described.

### Reviewing Advertisement History

FIG. 6 shows a reviewing advertisement history flow chart 600 in which at a stage 604 the advertisement history is requested. At a stage 606, a proxy server is set up to insure that websites or third parties cannot trace user history. At a stage 608 the next record, corresponding to another advertisement viewed by the user, is read.

At a stage 610 the program determines that the end of the file is reached and the banner program is stopped at stage 122.

If the end of the file has not been reached, the program proceeds to a stage 614 to display further advertisements in the user history.

At a stage 616 if it is determined if there are no further records or links associated with a given advertisement, the banner program proceeds to a read next record stage 622 and views the history regarding another advertisement.

At a stage 618 it is determined if the user wants to see a link associated with a given advertisement. If the user replies in the affirmative, the program proceeds to a display link stage 620.

If the user replies in the negative with respect to viewing the link, the user is returned to read next record at stage 622. The process of returning to stage 622 after stage 620 is repeated until reaching end of file stage 610.

In embodiments, in addition to providing advertising banners, the program maintains a history of what advertisements that a user clicked and purchased. Based upon the revenues generated by the purchases, a form of revenue sharing with the users may optionally be provided.

The method for revenue sharing may entitle the user enterprise company to receive a percentage of the cash received by the advertisers. Alternatively, the banner program can be programmed to tally user purchase points, according to a value system based upon the amount of revenue the user generates; with the number and value of the tally points determined by the advertiser or enterprise company. Optionally, the user will have the option to trade the tally points for other products the advertisers are offering.

In addition, the advertisers are able to generate a report or inquiry to determine the effectiveness of their advertisements and web pages based upon the number of views and/or clicks.

In still further embodiments, the banner program tracks the sites that the user has visited during a given session. Based upon the visited site and content, the banner program provides advertising that is related to information displayed on the user screen.

The user and/or advertisers additionally have the option to display the advertisements only when the user is viewing a specific display or website or, alternatively, to repeatedly show the same advertisement when the user has switched to a display that is not directly related to the advertised product.

In further embodiments, the banner program includes a search engine to search for a product, service or other items. Additionally, the banner program is capable of accessing multiple search engines and the results are displayed to the user in an overlay screen.

In embodiments, the results are displayed in a popup screen after the user has made a selection; the popup screen offering the user additional possibilities for selection. In some embodiments, the popup screen may be limited to user-specific options, for example offering target advertisers in the specific geographic location of the user.

To ensure proper overlay of advertising, the banner program includes a system for measuring the available overlay space on the screen and fitting the advertising banner and/or popup to the available overlay space.

In further embodiments, the user can specify that the banner program provide alerts for special deals that become available in preferred product categories. For example, the user has searched for two-man tents on a given day. A few days later a supplier, for example Costco, advertises a two-man tent at a lower price, the user can specify that the banner program display the two-man tent even if the user has not requested information on that product in the interim.

In embodiments, the banner program displays discount coupons that are valid for a period of time, for example one week, and remind the user during the week that the coupon validity period is waning.

Additionally, the user can enter the program and specify preferences, for example where the overlays should be located on the screen, whether to show the advertisement when the user is not connected to the internet, the amount of display time for each overlay, the time between displaying multiple overlays and/or how many advertisements to overlay during a given period of time.

In embodiments, the present invention allows the users to review all of the advertisements received through the banner program and/or specific advertisements. In further embodiments, the user may review advertisements seen on a given day, or advertisement overlays that are related to a specific product category.

Further, the user has the ability to click on the advertisement to link to a specific website and then click to return to the original advertisement and/or previous advertisements that have been displayed by the banner program.

In addition to on-line advertising, the present invention allows advertising on non-Internet based programs; the following being an example of one such application.

### Non-Internet Advertising

FIG. 7 shows chart 700 that illustrates a protocol when not connected to internet wherein at a stage 704, based upon the program related to flow chart 500 (FIG. 5) the program determines if there is a request to access an Internet website. If there is a request, the user enters a stage 506 of flowchart 500. If there is no request, meaning that the user remains off line, at stage 706 the banner application analyzes what applications are running. At a stage 708, based on the profile and the type and size of the advertisements within the application, new advertisements are retrieved.

At a stage 710 advertisements are offered by a variety of vendors and sorted by category.

At a stage 712 advertisement keywords are used in the sorting and categorization of advertisements.

For example, during multiple sessions of a given user, the banner program tracks the sites, areas of interest and products that the user has accessed and stores this information in a storage module.

During a future session that is offline, wherein the user is working on a spreadsheet that is dealing with sports, the banner program will identify the keyword “sports” and associate the keyword with prior products and/or areas of interest shown by the user. The banner program will then display banners that have been stored in the software storage module and are associated with the keyword.

At stage 358, it is determined if the owner of the computer display, for example a program owned by a company, allows change in copyrighted content.

If the copyrighted material allows changes to the display or a portion of the display, at stage 354 the advertisements are retrieved and sized according to the available size and location for the retrieved advertisement. At stage 362, the advertising overlay is embedded into the user display.

In some embodiments, where the display owner prohibits changing the display, advertisements are overlaid on the display. In embodiments, this feature may be activated when the user accesses a company website and/or, inter alia, on programs, documents or spreadsheets displayed on the user computer.

If, at 358, the user data display prohibits overwriting, the original user display is maintained at stage 360 and, at stage 364, the advertising overlay is overlaid on a designated portion of the user display, for example over a pop-up or an embedded graphic box.

Embodiments of the present invention provide tracking of user history, secure access to e-mail, and automatic gating against users accessing sensitive government data; the following being just one exemplary embodiment.

### Government and Certified Site Protection

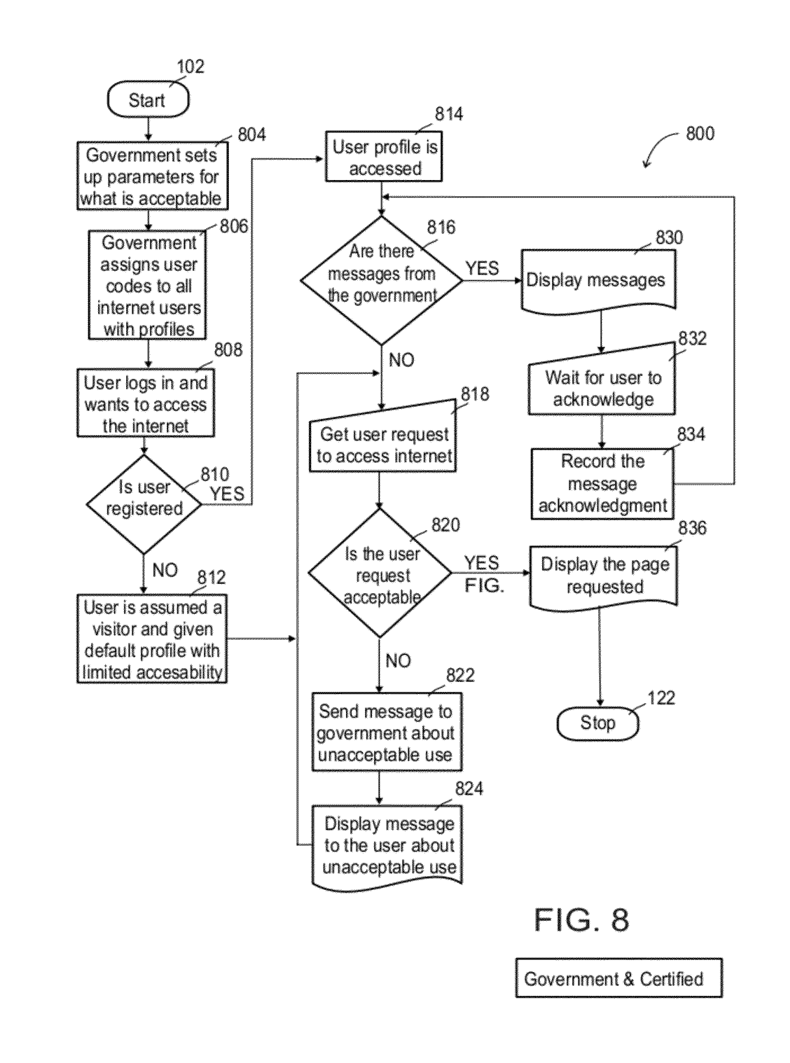

FIG. 8 shows a government and certified site flow chart 800 wherein at a stage 804 a government agency sets up parameters for what is acceptable for users to view.

At a stage 806 the government agency assigns user codes to all internet users with profiles. At a stage 808 the user logs in and signals a desire to access the internet.

At a stage 810 the program determines if the user is registered. If the program determines that the user is not registered, at a stage 812, user is assumed to be a visitor and given a default profile with limited accessibility.

In such cases, the user then accesses an Internet 818 stage in which the user requests access to internet. However, the user cannot access a stage 814 which begins the options related to message retrieval.

If the program determines that the user is registered, at stage 814 the user profile is accessed and at a stage 816 it is determined if there are messages from the government agency waiting to be read by the user.

At a stage 820 the program determines if the user request is acceptable, meaning that the internet website does not contain sensitive government documents. If the request is acceptable, the requested Internet page is displayed at a stage 836.

If the request is not acceptable, at a stage 822 a message is sent to the government agency regarding the unacceptable request. Additionally, at a stage 824 a message is displayed to the user about the unacceptable request and denial of access.

The user is then returned to stage 818 to request another Internet website.

Referring back to stage 816, if there are messages, at a stage 830 the messages are displayed. At a stage 832 the program waits for the user to acknowledge the messages and at a stage 834 the program records the user message acknowledgment.

In embodiments, the present invention provides multiple search options to the user, all of which are hidden from unauthorized parties; the following being two examples of such search capabilities.

### Search Override

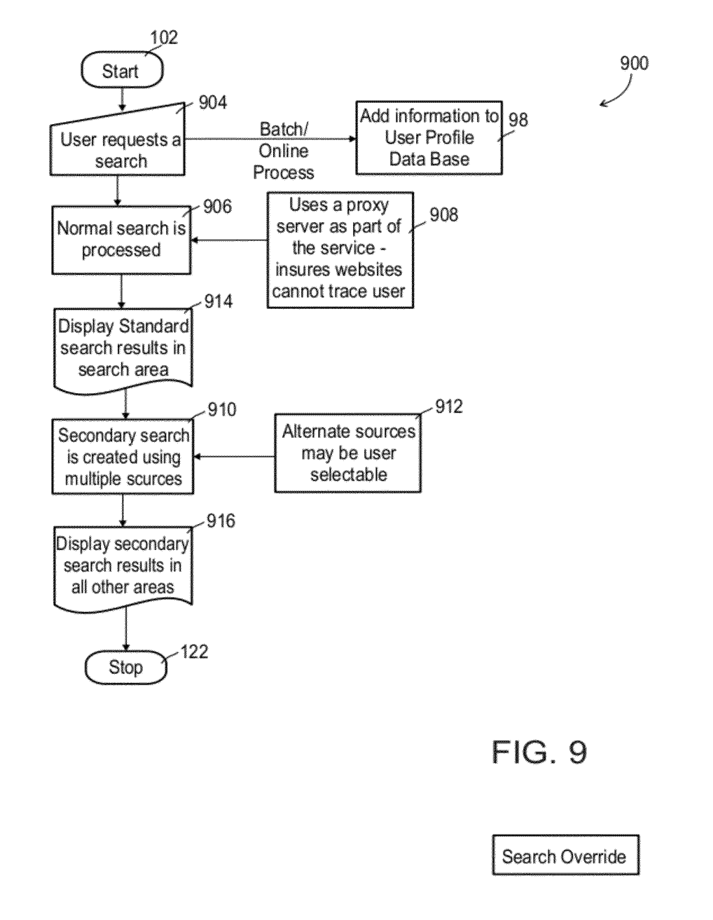

FIG. 9 shows a search override flow chart 900 wherein at a stage 904 the user requests a search. At a stage 906 the user begins a regular Internet search process and a stage 908 is accessed in which a proxy server is included in the service to insure that the user history cannot be traced by third parties, for example other websites.

At a stage 910, wherein the user has shown a preference for certain specific products and/or product categories, a secondary search is created using multiple sources; for example Google and AOL or any of a variety of alternative search engines. In such instances, the banner program will “fine tune” the user query and present the information to the multiple search engines.

For example, initially, the user requested information on sports cars in general. Following display of the information regarding sports cars, the user makes a second request for specific information regarding sports cars having a specific horsepower. The second request is transmitted to the multiple sources and the advertisers provide the second search information. Optionally the banner software orders the advertisements beginning with the advertisement that is closest to the user parameters and/or secondary search parameters.

At a stage 912 the user selects one of the alternate sources; for example an alterative search engine comprising MSN.

At a stage 914 search results are displayed on the user screen. At a stage 916 secondary search results for additional search topics are displayed.

### Alternate Search Override

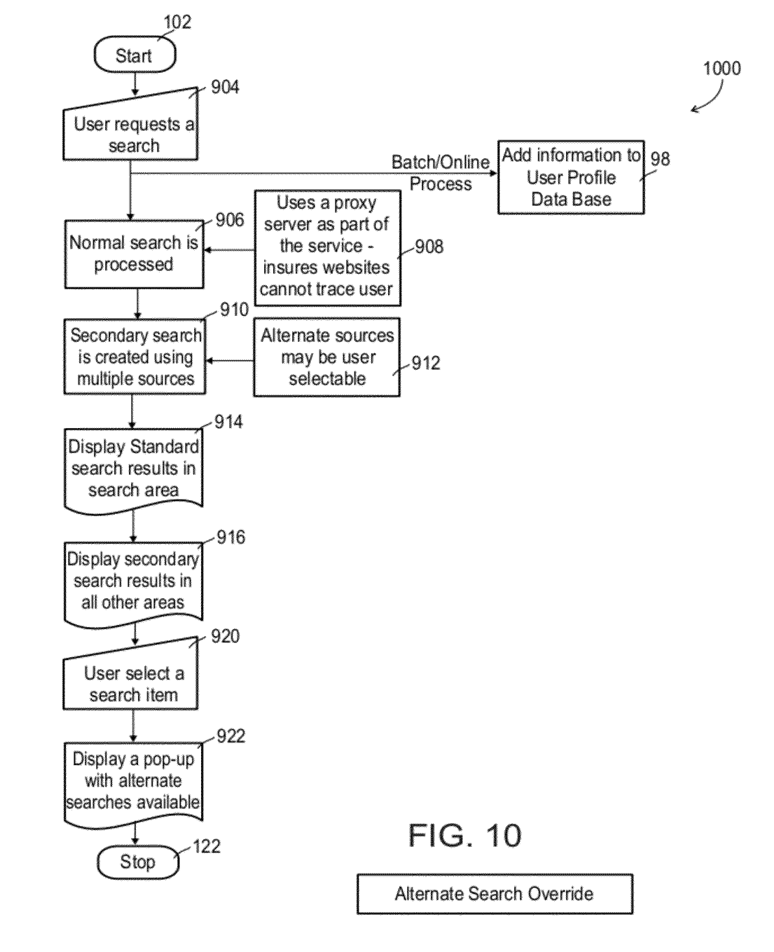

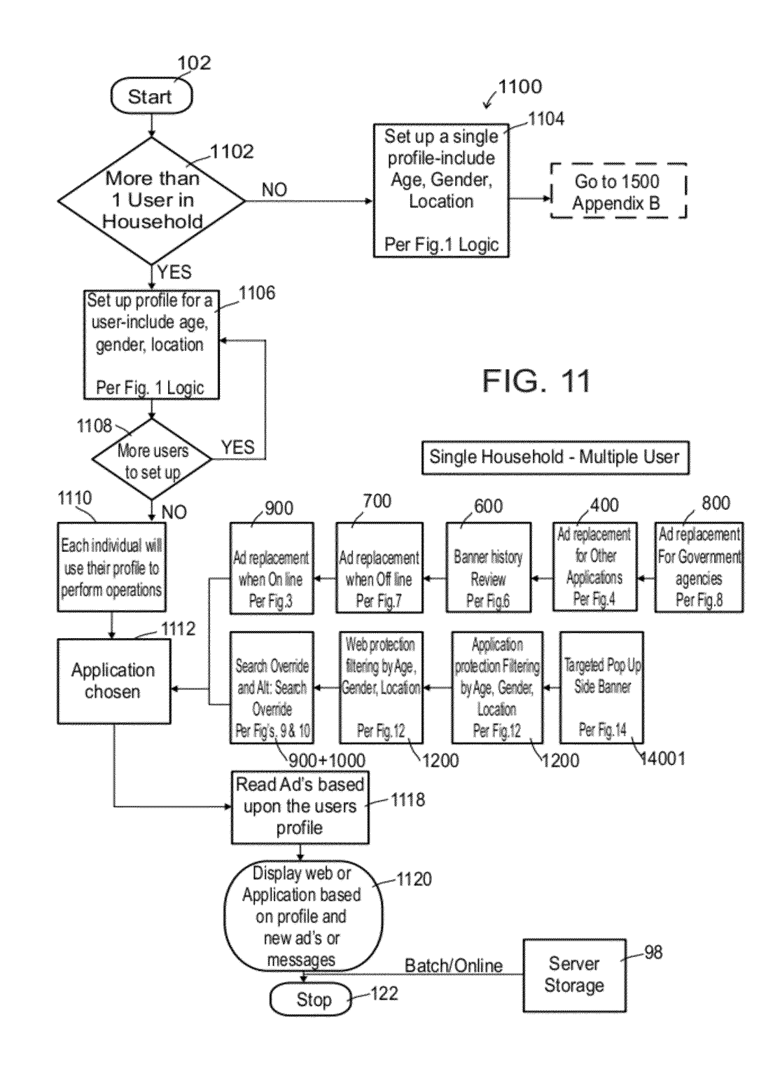

FIG. 10 shows an alternate search override flow chart 1000 in which all stages of flow chart 900 (FIG. 9) are repeated until display secondary search results in all other areas at stage 916. At a stage 920 the user selects a search item and at a stage 922 a pop-up with alternate available searches is displayed.

In embodiments, the present invention allows multiple users on a single computer to search the Internet and to each receive specific advertisements that are geared to the individual user age, gender and/or other parameters. The following is just one option for providing such services to multiple users.

### Single Household

FIG. 11 shows a single household flow chart 1100 in which, at a stage 1102 it is determined if there is more than one user using a single computer. If there is only one user, at a stage 1104 a single user setup profile is accessed and information is entered for the user which includes, inter alia, age, gender, geographic location, as per flow chart 100 (FIG. 1e).

If there are multiple users on the computer, at a stage 1106 multiple set-up profiles are entered, each including, inter alia, age and gender of that user. If additional users access the computer at any time, an additional user registration stage 1108 is accessed and user information is entered at setup profile stage 1106. Following registration of all users, at a stage 1110 each individual uses their profile to perform operations.

At a stage 1112, an application is chosen which may include a variety of above-described applications related to flow charts 300, 400, and 600-1000. Additionally these applications may include a targeted pop-up side banner protocol 1400 (FIG. 14) that will be described below.

At a read advertisements stage 1118, the advertisements are analyzed and alternative advertisement overlays are chosen based upon the user's profile. At a display web or application stage 1120 the alternative advertisements are displayed as overlays or embedded within the display.

The instant invention additionally protects a user from accessing inappropriate websites and/or filters material out of a given website display, using the user profile as a basis for such protection; the following being one example of this protocol.

### Internet Browsing Re-Login

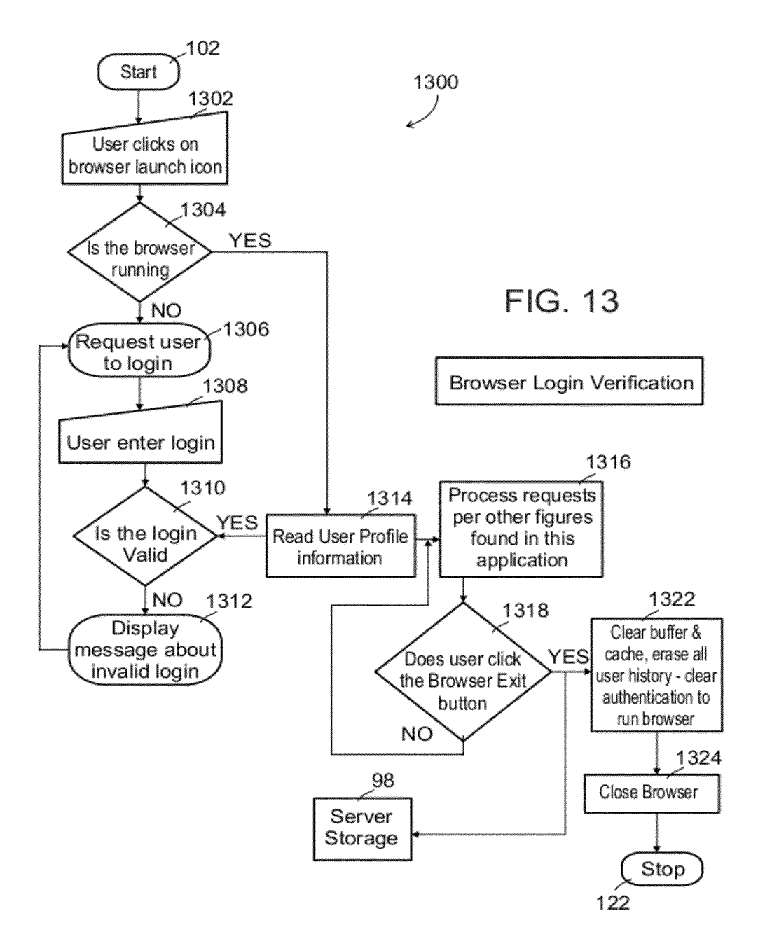

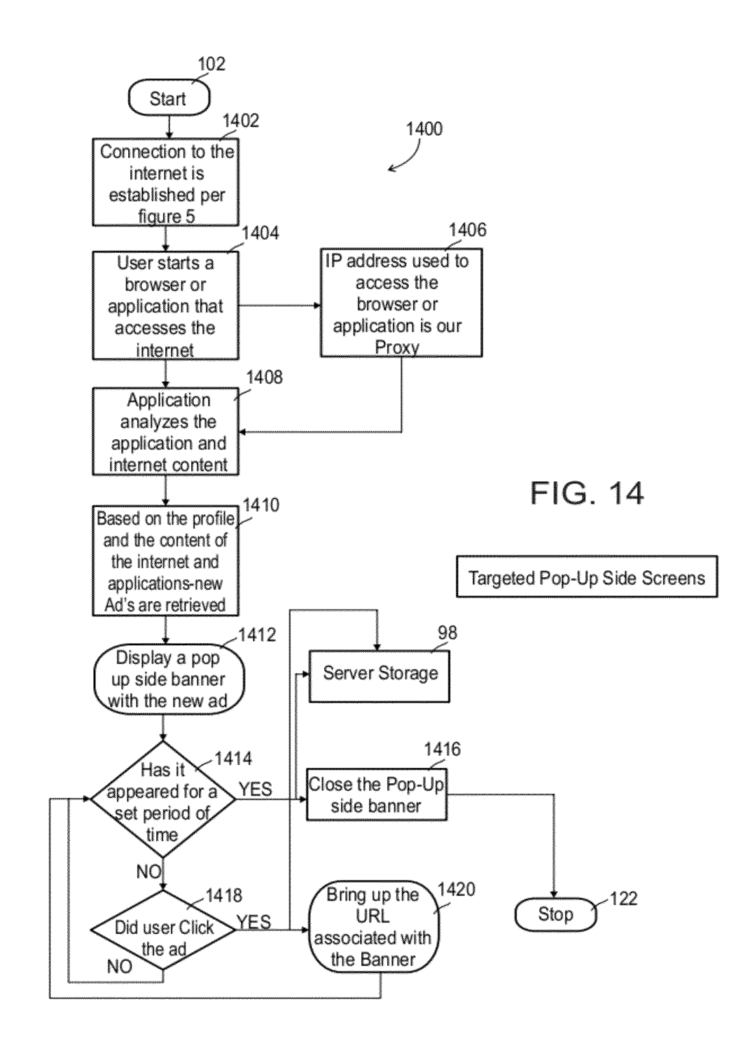

FIG. 13 shows an internet browser flow chart 1300 that includes login verification on every Internet launch. At a stage 1302 the user clicks on browser launch icon. At a stage 1304 the program determines if the browser is running.

If the browser is running, at a read user profile stage 1314 the user profile is compared at a stage 1316 against the material and figures found in the application displayed by the browser. The protocol for filtering and protection either stops the application or filters the material in the application.

At a stage 1318 the protocol determines if the user clicked to exit the browser. If the user has not exited, the protocol returns to stage 1316 to continue the monitoring process.

If the user has exited the browser, at a stage 1322, all buffers and caches are erased so that user history is completely cleared from the computer. Additionally, a stage 1324 is accessed wherein the browser is closed.

Returning to stage 1304, if the browser is not running, the user is requested to login to the browser at a stage 1306, and at a stage 1308, the user logs into the browser using, for example, a predetermined password.

At a stage 1310, the login is determined to be valid and the user proceeds to stage 1314 wherein the user profile information is read and the protocol proceeds to monitoring stage 1316.

If the login is not valid, a stage 1312 is accessed in which a message is displayed that informs the user of an invalid login and the user is returned to stage 1306 to begin the login process again.

In addition to providing embedded and overlaid advertising, embodiments of the invention provide pop-up screens that are positioned, for example, on the side of a screen display of a computer-based program or Internet display; the following being one example of such a protocol.

### Targeted Pop up Side Screens

FIG. 14 shows targeted pop-up side screens flow chart 1400 in which at a stage 1402 a connection to the internet is established as per flow chart 500 (FIG. 5).

At a stage 1404 the user starts a browser or application that accesses the internet while, at a stage 1406, the computer IP address is used to access the browser or application via a proxy server.

At a stage 1408, the protocol analyzes the application and internet content and, at a stage 1410 new advertisements are retrieved based on the user profile and the content of the internet and applications.

At a display stage 1412, a popup side banner with a retrieved advertisement is displayed. If, at a stage 1414, it is determined that the pop-up has appeared for the set period of time, described above, the pop-up is closed at a stage 1416.

If the period of pop-up display time has not been reached, at a click stage 1418 the protocol determines if the user has clicked an option related the advertisement; for example a radio button leading to a second pop-up that provides additional information regarding the advertised subject matter.

At a URL stage 1420, the URL associated with the pop-up banner is accessed, following which the program is stopped.

### Application Startup

FIG. 15 shows a Web Browser flowchart 230 which continues from registration “S” and “C” in FIGS. 17 and le respectively, in which at stage 102 the application starts. At a stage 232 the user profile is retrieved and at a stage 234 periodic popup advertisements are provided on the host computer. The popup advertisements are, at this stage, generic ads based upon the user profile which were provided. Generic ads continue to be displayed until the identity of the user is confirmed and the prior user advertisement history is accessed.

At a stage 236 login page is displayed and, should the user wish, at a stage 238 the user selects a new ID and at a stage 240 the user enters the registration process for the new ID.

In the absence of choosing a new ID or should the user accept the original ID, at a stage 242 the user enters authentication credentials and at a stage 244 the validity of user credentials is determined. Following providing proper credentials, at a stage 262 retrieve user specific advertisements, and at a stage 264 display toolbar process begins.

If however, at a stage 246 the user credentials are invalid, the invalid credentials screen is displayed and at a stage 248 the user selects retry and, if unsuccessful in providing proper credentials, at a stage 252 the application terminates.

If the user is unsure of credential validation, for example the user pin, at a stage 254 user selects “contact support”. Following contact support, at a stage 256 client opens default email of the application provider and at a stage 258 user sends email to support.

At a stage 260 the support supplies credentials to the user via e-mail and the user proceeds to login stage 236.

The present invention contemplates allowing the user to browse the Internet while switching between languages, for example from English to German. The following Flowchart provides just one example of multiple language options.

### Display Toolbar Process

FIG. 16a shows a display toolbar process flowchart 270 which continues from “Q” of FIG. 15.

At a stage 266 the toolbar of the application software is displayed and the generic ads previously displayed during login are now replaced with user-specific ads that reflect the user past click stream and preferences. For example, if in a previous session, the user clicked on advertisements relating to automobiles, automobile ads are displayed.

When the user decides to terminate the application, at a stage 268 the user selects logoff and at a stage 269 the application begins the shutdown process and terminates at stage 252.

At a stage 272, the user selects the language, for example switching from English to German and at a stage 274, the application sets the UI (User Interface) language parameter. At a stage 276 advertising language is set and at a stage 278 the advertising language is updated to the UI language and ads are displayed in the newly selected language, German.

At a stage 280 the user selects secure surfing with IE and at a stage 282 the user sets the browser parameter to IE, which is displayed in the chosen UI.

Alternatively, at a stage 284 the user selects secure surfing with web browser (e.g. Firefox, etc) which is displayed in the UI, and at a stage 286 sets browser parameter to web browser.

Following entering either a web browser or Internet Explorer, the user proceeds from box “R” to FIG. 16B.

### Secure Surfing

FIG. 16B shows a secure surfing flowchart 370, in which at a stage 372 the user clicks on an advertisement provided in the user-specific popups noted above. At a stage 374 display advertisement and at a stage 376 the application software retrieves a list of proxy servers. At a stage 378 determine fastest proxy server and at a stage 380 the application software opens a secure communication channel to the proxy server via the internet. The software application then determines if the proxy server is running at a stage 382 and whether the proxy server is performing properly at a stage 384. If the proxy server is not running, the software application returns to stage 376 to retrieve an updated list of proxy servers.

When the proxy server is determined to be running and performing properly, at a stage 386 the application software creates or opens secure surfing vault(s) and at a stage 388 the browser proxy server is changed to allow encryption of the surfing history.

At a stage 390 change browser's history, cache, favorite sites and bookmarks which are directed to a new secure surfing vault and at a stage 392 the application software determines if the browser is Internet Explorer.

At a stage 394, for example if the user types www.personalweb.com, the URL is securely stored in the secure surfing vault. At a stage 396, history, cache, favorites, and bookmarks are saved in the secure surfing vault(s).

If the browser is determined to be different from Internet Explorer at stage 392, at a stage 397 the advertisement is closed and at a stage 398 a default web page is launched in the selected browser so that at a stage 399 the user is now able to surf securely.

In embodiments, the present invention, in addition to tracking the user click stream, tracks user preferences as evidenced by keywords the user types into the Web Browser, and displays user appropriate advertising based thereon. The following flow chart presenting just one option in how keywords are tracked and advertisements are provided.

### Keyword Tracking

FIG. 18 shows a keyword tracking chart 550 which continues from FIG. 16B in which at a stage 552 the user initiates a search utilizing keywords. At a stage 554 the application “listens”, meaning that the application follows user input to determine the keywords the user has input.

At a stage 556 the application determines if keywords were input and if not, at a stage 562 the application terminates keyword processing.

If keywords were input while the user is working with an Internet-based program, for example a community networking site, at a stage 558 the application determines the keyword parameters and at a stage 560 an advertising engine is accessed and proceeds to overlay the screen with advertising banners at a stage 569.

If keywords were input while the user is surfing with the Web Browser, at a stage 564 search request is sent to host, at a stage 566 the application analyzes the returned web page. At a stage 568 the host computer displays the requested page on the Web Browser and at stage 569, the application displays ad overlays on the Web Browser page.

In displaying advertising overlays, the present invention contemplates a variety of control parameters to provide the advertising in a pleasant manner that allows, for example, a time-sharing protocol between the ad overlay and the underlying advertisement provided with the Web Browser. The following flowchart demonstrates just some of the control parameters and display methods that are contemplated.

### Ad Overlays

FIG. 19 show an ad overlays flowchart 520 which is a continuation of box “B” of FIG. 18, in which at a stage 522 the user profile is retrieved and at a stage 524 the user prior preferences are retrieved. As noted above, the user profile constitutes, inter alia, the user age and gender; while the user prior preferences constitute the prior surfing history, products accessed by the user and keywords entered during secure surfing.

At a stage 526 the application determines appropriate ads based upon the user profile and preferences.

At a stage 528 the application determines whether it is necessary to analyze the screen to determine the areas where the overlays should be placed.

In some embodiments, the delay in displaying the overlay and the amount of time the ad overlay is displayed and where the ad overlay is placed, herein the ad control parameters, are predetermined based upon defaults at a stage 534. For example, the application determines that the user is surfing using a Web Browser that has a known screen format and that determination of the location for placing advertising overlays can continue using default parameters.

In alternative embodiments, at stage 528, the application software determines that it is necessary to analyze the screen. For example, if the user is surfing, the dimensions of the areas for the advertising overlays may vary. In such cases, for example, at a stage 530 the application analyzes the Web page and determines that a targeted advertising box is located along the length of the right side of the screen and measures 6 centimeters in width. At a stage 536, the application determines the control parameters governing the advertising overlays.

In embodiments, the ad control parameters are dynamic. For example, at a stage 532, an animation screen may display a car driving on the highway with repeating scenery. In such instances, the application software may analyze the animation screen to determine the time period that occurs prior to repeating the scenery and time the overlay to appear at the beginning of a repetition and to end as the scenery repetition comes to an end.

Whether the ads are placed by default at stage 534 or based upon analysis of the Web page, at stage 536, advertising controls are applied based upon words and location of advertising within the web page.

For example, in embodiments, the application will allow the user to see the advertisement provided by the Web Browser for a given period of time at a stage 538, thereby allowing the Web Browser advertiser the courtesy of encouraging the user to initiate a click stream. Following the given period of time, the ad overlay will be displayed over the Web Browser targeted advertising box and will continue to display for a given period of time, after which the overlay is removed; again as a courtesy to the advertisers listed in the targeted advertising box.

At a stage 540, the application records, the displayed ads; and at a stage 542, all ads that are clicked are recorded and stored, for example in a data base.

Credits from user purchases on the Internet are allocated from the vendor to the Web Browser to provide reimbursement, often on a percentage of the sale price. In embodiments, when the application software is provided by an ISP, for example Internet Explorer, the present invention allows the ISP to receive reimbursement for user purchases that were made as a result of advertisement overlays. The following flowchart demonstrates just one example of how the ISP can track the user advertising history, thereby ensuring proper reimbursement.

### Advertising History

FIG. 20 shows an advertising history flowchart 420, in which at a stage 422 the ISP logs into advertising module stored, for example, in a secure vault on the sever. At a stage 424 the advertising module enters a retrieval mode to determine that ISP has the permission of all the users of the advertising module to gain access and at a stage 426 the advertising module determines if such permission has been granted. Should there not be permission, at a stage 428 the ISP login is terminated.

In embodiments, at the initial login of each user, each user grants permission for the ISP to view advertising history and the advertising history of all the users granting such permission are stored in a common vault in a database located on a server.

If the ISP has the permission of all the users, at a stage 432 the advertising history of the group of users granting permission is displayed on an advertising history page. At a stage 434, the ISP clicks on a specific user to determine the click stream and at a stage 436, the ISP determines, for example, whether a purchase was made.

The ISP will then return to stage 432 and display the advertising history of another user, and repeat the process of reviewing the advertising history, and recording user purchases, until having reviewed all information contained at stage 432 on the history page.

While the present invention has presented a number of options when the user has chosen to access a Web Browser after login to the Web Browser, there may be instances where the user accesses the Internet without logging onto the Web Browser. The following flow chart presents just one of the many options for providing advertising overlays when the user has accessed a Web page without logging into the Web Browser.

### Web Links

FIG. 21 show a web links flowchart 570, in which at a stage 572 the user clicks on a link to a web URL address, the link being embedded for example, in an e-mail.

Alternatively, the link is embedded in a Web site on the Internet.

In still further embodiments, the link is embedded in at least one of: i) a computer program;

ii) a chat room;

iii) an instant message; and

iv) a blog.

In embodiments, the advertising software includes a mode in which it runs in the background to sense embedded links and user responses thereto, without being associated with the Web Browser and/or ISP.

At a stage 574 the advertising application listener process intercepts the request to access the URL address. At a stage 576, the advertising software determines if the application software is running and, in the event that the software is not running, a stage 578 is accessed and user generic ads are retrieved at box “N” of FIG. 15. In embodiments the stage 640 Requesst routed to application secure surfing, the flowchart continues with stage 576 of FIG. 21. Determination as to whether advertising application is running, at a stage 580 secure surfing starts and FIG. 16B is accessed to provide appropriate advertising overlays.

Should the user simply requests to access a single Web page, for example customer service for a given program, a stage 582 is accessed, the requested Web page is opened and an advertisement overlay is placed on the requested Web page using control parameters noted above.

In some instances, the Web Browser associated with the advertising application may become overloaded with user requests, resulting in delays in providing advertising overlays. Such delays may result in loss of sales to the vendors provided by the advertising application. The following flow chart presents just one system by which delays in providing advertising overlays are shortened.

### Default Browser Time Out

FIG. 22 shows a default browser time out flowchart 630, in which at a stage 632 the user launches the default OS (Operating System) Browser. At a stage 634 the user enters a web site address and at a stage 636 the listener process watches the user requests by way of, inter alia, click streams or keywords.

At a stage 638 the application determines if the request is taking too long and if the answer is positive, at a stage 642 request is routed to an alternative browser associated with the advertising application so that advertising overlays are provided in a timely fashion.

If the response to the user request is not taking too long, at a stage 640 the user request routed to secure surfing associated with the application and box “T” of FIG. 21 is accessed.

In some instances a user host computer is inactive for a period of time, for example as evidenced by a lack of click streams, the computer may initiate a time out until the user is active at the computer.

During the time out, the computer enters a sleep mode during which the advertising application may become disconnected from the Web Browser so that when the user resumes use of the computer, the advertising software is unaware of the resumption of activity. The following flow chart presents just one option by which the advertising application establishes connection with the Web Browser following such a period.

### Restart Computer

FIG. 23 restart computer flowchart 650, in which at a stage 652 the user or system restarts the OS, the latter for example following a period of inactivity. At a stage 654 user clicks on web links and accesses a default browser flowchart 730 as shown in FIG. 25, explained below. Alternatively, at a stage 658 the user begins secure surfing.

In some instances, a user may access information from a proxy server via a remote computer, for example, a user who decides to finish work at home during an evening following a day on the office computer.

The following flowchart presents just one example of how the user history from the host computer and the remote computer are saved for review, for example by the user.

### Universal History

FIG. 24 shows a universal history flowchart 660, in which at a stage 662 user logs in successfully onto a first computer, Computer “A” and at a stage 664 the user securely surfs. At a stage 666 the user enters website (e.g. “abc.com”) and at a stage 668 history, cache, favorites and

URLs are saved in secure surfing vault. At a stage 670 the user logs off the application and closes computer “A”.

At a stage 672 the user successfully logs onto a second computer, computer “B”, located for example at a remote location with respect to computer “A”. At a stage 674 the user securely surfs and at a stage 676 the user enters a website (e.g. “xyz.com”).

At a stage 678 history, cache, favorites and URLs are saved in secure surfing vault.

At a stage 680 user clicks on browser history and at a stage 682 the user sees the websites and advertising history from “abc.com” from computer “A”; as well as from “xyz.com” as entered on computer “B”.

It should be noted that the user history of both computer “A” and computer “B” may alternatively be accessed from Computer “A” or even from a third remote location, computer C.

In still further embodiments, computer “A” uses a first operating system, for example Microsoft XP, while computer “B” uses a second operating system, for example Microsoft Vista. The advertising application at stage 682 established communication with both Microsoft XP and Microsoft Vista and displays the advertising history. Optionally, the advertising history is combined, using appropriate software modules so that the entire history from both computers “A” and “B” are displayed on a single page.

In some applications, the advertising application is provided as a package with the Operating System and the user is given the option to receive, at a discount or without payment, the secure surfing program along with secure vaults, provided that the user accepts the advertising application.

Following setup of the OS, the user may not specify a Web Browser, for example AOL or Yahoo. In embodiments, when a Web Browser is not specified, the application software provides a default Web Browser; and one such flowchart is now presented.

### Default Browser

FIG. 25 shows default browser flowchart 730, in which at a stage 732 the advertising application provides a default browser provided with the OS program. At a stage 734 user launches browser and at a stage 736 the advertising application launches and the user successfully logs in, at which time the user is referred to box “N” on FIG. 15 to continue surfing.

In alternative embodiments, at a stage 738 the user begins secure surfing with the default Browser and enters the flowchart depicted in FIG. 16B.

In still further embodiments, at a stage 740 following a user request for a given web page, the requested web page is opened.

In some embodiments, the ISP has the option to access the user advertising history and provide advertising provided by competing companies that are not offered by the ISP. In such cases, the ISP has the option to offer alternative company products from ISP-registered companies; the following Flowchart being one example of how this is accomplished.

### Identifying Users That Are Competitors

FIG. 26 shows a Retrieve User Specific Advertisements flowchart 860 in which, at a stage 862, company “A” provides hardware and/or software for user and at a stage 864 the end user starts using provided hardware and/or software.

During a subsequent session, following login by the user at a stage 866, at a stage 868 the running applications are identified and if the end user is an end user of company “A”, at a stage 870 there is normal application flow with no additional ads being provided to the end user.

One means of determining whether an end user is a customer of company “A” is based upon the IP address of the destination associated with company “A”; still further options being known to those familiar with the art.

If, however, the end user is not a customer of company “A”, at a stage 872, company “A” advertisements are added to a list of ads to show. Further, at a stage 874, additional criteria are applied for determining appropriate advertisements. For example, the user's prior purchases of hardware or software may suggest specific areas of interest and advertisements are additionally provided based upon this information and user profile parameters.

Following determination of additional criteria, the toolbar process is displayed at a stage 876.

In addition to end user purchases, advertising may be provided based upon the applications running on the host computer. The following flowchart providing one example of providing advertising based upon the applications running on the host computer.

### Identifying Running Applications

FIG. 27 shows an Identifying Running Applications flowchart 880 in which at a stage 882, the user logs successfully and in paralle accessing occurs in which stage 889, the Toolbar Process is displayed, while at the same time, stage 884 is accessed wherein running applications are identified.

At a stage 886, applications running on the host computer are identified; examples of which could be Skype, MSN, MS Office, and etc. Additionally, the program periodically checks for additional applications that are launched; and the flowchart loops back to stage 884.

At a stage 888, relevant banners for running applications are displayed. Relevant banners could be displayed based upon competitor products or offers for existing applications.

In some embodiments, the user has the option to specify specific security options via the software program provided to the host computer, for example limiting access to inappropriate adult sites for a child family member.

In systems in which the child accesses the host computer with a portable session management device, for example a USB key programmed with software that restricts surfing, the present system provides the option to enter the restrictions via the running software and/or the USB key.

### User Specified Security Options

FIG. 28 shows a user specified security options flowchart 930 in which at a stage 932, the user logs in; and at a stage 934, the toolbar process is displayed.

At a stage 936, the responsible part, for example a parent or guardian, selects security options and security options are displayed at a stage 938.

In embodiments, from stage 938, the user has several options to restrict computer use:

i) At a stage 940, the user Enables/Disables protection of all Internet Traffic and at a stage 942, All Internet Traffic Processes are Protected or Unprotected.

ii) At a stage 944, the user has the option to enable or disable protection of all Browser Traffic so that at a stage 946, Browser Traffic Process becomes protected or unprotected.

iii) At a stage 948 the user may enable or disable protection of all e-mail Traffic so that at a stage 950, e-mail Traffic Process is protected or unprotected.

iv) At a stage 952 the user has the option to Enable or Disable protection of all Voice-over-Internet protocol (VoIP) Traffic and at a stage 954, all VoIP becomes protected or unprotected.

As used herein, VoIP refers to
1. a protocol optimized for the transmission of voice through the Internet or other packet-switched networks; and
2. the actual transmission of voice, rather than the protocol implementing it.

Following the implementation of one or more restrictions on the host computer, the instant invention contemplates a variety of user interfaces that apprise the user of such restrictions. The following flowchart provides just one example of such a user interface.

### Safe House Web Surfing

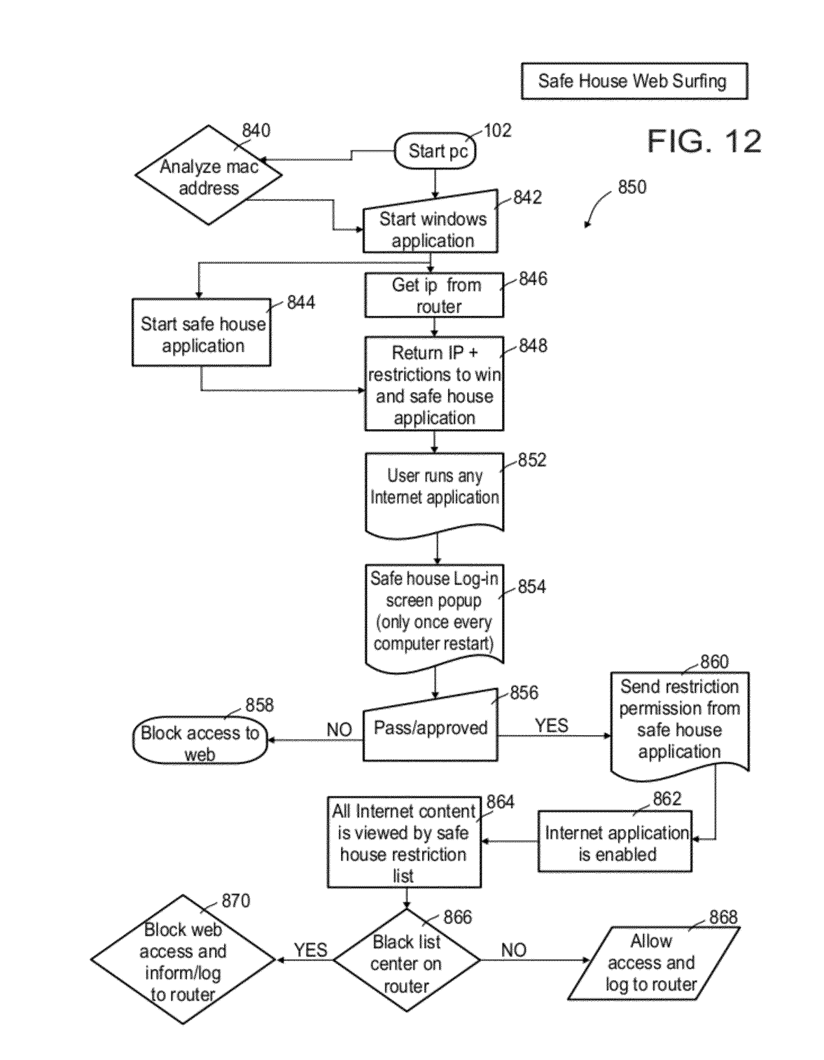

FIG. 12 shows a flow chart 850 depicting Web surfing through a safe house protection system in which, following start stage 102, the Windows application is started at stage 842.

During start up of the Windows application, the Media Access Control (MAC) address is accessed using an identifier associated with the user, at a stage 840. Following the start of Windows, while the internet protocol address is provided by the router and/or proxy server at a stage 846, a stage 844 is accessed in which the safe house application is begun 848.

The safe house application establishes restrictions on the Web sites, blogs, e-mail and chat rooms that the user can access. For example, a user who is a member of a religious group and uses an IP provided by the religious group will be subject to the restrictions set by the Webmaster of the religious group. Optionally, for example, the religious group has set limitations that restrict member access to pornographic Websites and/or of Websites of groups related to alternative religions.

At a stage 852, the user accesses an Internet site and at a stage 854, a popup screen informs the user, prior to accessing the IP, that the host computer is being guided during Web surfing by the Safe House software.

At a stage 854, the content of the accessed Website if analyzed and inspected for approval for viewing by the user such that the Website is blocked at a stage 858 if the content is found to be inappropriate.

Should the Website found to be appropriate, at a stage 862, permission to view the Website is granted and at a stage 862, the Website is accessed.

Additionally, all material provided by the approved Website is reviewed at a stage 864 and referred to a black list stage 866 in which the black list reviewer on the router determines, for example, at a stage 870 that the specific material offered through the approved Website is inappropriate and further access is prohibited, with the information on the prohibited address being recorded on the router.

In addition to determining the appropriateness of the material offered on the approved Website, stage 870 analyzes secondary Websites, blogs, and chat rooms that are accessed through the approved Website. Non-approved sites, blogs and chat rooms, for example, may be accessed through popup menus that take the user out of the approved Website.

If, during the determination at stage 866, the material is found to be appropriate, the user is allowed access to the material at a stage 868 and information regarding the secondary Websites, blogs, and chat rooms is recorded in the router. Additionally, all surfing history is encrypted and stored on the server as described, for example, in flowchart 200 (FIG. 2).

In some embodiments the user accesses a Website not registered with the ISP and surfs through a variety of products. In such cases, it may be desirable to alert a registered Website, in real time, to the user surfing and product preferences so that the registered Website can display competing products.

The following flowchart presents just a few of the many options by which profile information is sent to registered Websites.

### Pushing Profile Information to Partner Websites

FIG. 29 shows a flowchart 960 depicting pushing profile information to Partner Websites in which at a stage 962, the user Logs in. At a stage 964, the User Starts to Surf Securely and at a stage 966, the user surfs to a website. At a stage 968, a determination is made if the Website is not registered with the ISP.

If the Website is registered with the ISP, at a stage 970 the advertisements are displayed. The user then may continue surfing the Web and returns to stage 966.

If, however, the Website is not registered with the ISP, at a stage 972, profile information of the user is sent to a Website that is registered with the ISP and at a stage 974, the registered Website displays advertising that is customized to the user profile, noted above.

It should be noted that the type of information shared with ISP-registered Websites may vary based on partnering agreements and/or user preference history.

For example, the user history may show that the user search parameters include only inquiries about the purchase of high-end with a high price tag. In such cases, the profile information would include, for example, information on the price range that the user generally selects so that the partner Website would restrict the banner display to high-end products that are optimally desired by the user.

In embodiments, the information sent to the registered Website is subject to prior agreements. For example, for the purpose of reducing costs, the registered Website may subscribe with the ISP to receive only specific products or categories of products. In such cases, the instant invention provides filters on the information passed on to the registered Website.

It is expected that during the life of a patent maturing from this application many relevant banner advertising protocols will be developed and the scope of the term banner advertising protocol is intended to include all such new technologies a priori.

As used herein the term “about” refers to ±10%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, an and the include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A computer advertising session management system configured for operating in conjunction with a host computer, the computer advertising session management system comprising:
i) an advertising module configured to provide advertisements associated with at least one computer-based application; and
ii) a safe access module operatively configured to facilitate safe access of the advertising module to said at least one computer-based application operating on said host computer.

2. (canceled)

3. The computer session management system according to claim 1, including a concealed encryption engine configured to operate with the host computer on at least one member of the group consisting of encryption of user-selected data thereon and concealing a portion of data thereon.

4. (canceled)

5. The computer session management system according to claim 1, wherein said system includes an authentication module associated with said safe access module, said authentication module configured to obtain authentication of said computer advertising session management system with respect to said host computer.

6. The computer session management system according to claim 5, wherein said authentication module includes at least one member of the group consisting of:
a) digital string comprising at least one of:
i) a session management system identifier;
ii) a user login name;
iii) a user password; and
iv) at least one user profile; and
b) digital string associated with at least two user profiles and at least one of:
i) a session management system identifier;
ii) a user login name; and
iii) a user password, associated with each of said at least two user profiles.

7-13. (canceled)

14. The computer session management system according to claim 1, wherein said advertising module is configured to provide an advertisement according to at least one user click of an embedded link associated with at least one of:
i) said at least one computer-based application; and
ii) said advertising module.

15. The computer session management system according to claim 14, including an encryption engine configured to operate with said host computer to provide encryption of said provided advertisement and said at least one user click of said embedded link associated with at least one of:
i) said at least one computer-based application; and
ii) said advertising module.

16-17. (canceled)

18. The computer session management system according to claim 15, wherein said encryption occurs following expiration of authentication by said authentication module.

19. The computer session management system according to claim 15, wherein said encryption engine is further configured to operate with said host computer on providing an encryption of said at least one computer-based application.

20-30. (canceled)

31. The computer session management system according to claim 5, wherein said authentication module is associated with at least one of:
i) a portable session management device configured for insertion into an input on said host computer; and
ii) a server configured to communicate with said host computer.

32. The computer session management system according to claim 1, including an advertisement overlay module configured to overlay at least one first advertisement on at least a portion of a display on said host computer, including a copyright module operatively associated with said advertising overlay module configured to determine whether a copyright is associated with said at least a portion of said display on said host computer, and wherein said copyright module is configured to provide said at least one first advertisement peripherally to a copyrighted portion of said display on said host computer.

33-34. (canceled)

35. The computer session management system according to claim 32, wherein said advertisement overlay module is configured to overlay said at least one first advertisement according to at least one member of the group comprising: a) a time parameter comprising at least one of:
i) time prior to said providing of said at least one first advertisement;
ii) time during said providing of said at least one first advertisement; and
iii) time between providing of said at least one first advertisement and providing at least one second advertisement: and
b) a display parameter comprising at least one of:
i) size of display peripheral to said copyrighted portion; and
ii) displayed advertisements to be overlaid.

36. (canceled)

37. The computer session management system according to claim 1, wherein said safe access module is configured to associate with at least one of:
i) a primary Internet site;
ii) a secondary Internet site reached via a primary Internet site; and
iii) an Internet site reached via an embedded link associated with said host computer.

38. The computer session management system according to claim 37, wherein said embedded link associated with said host computer is embedded in at least one of:
i) a computer program;
ii) an e-mail;
iii) an Internet site;
iv) a chat room;
v) an instant message; and
vi) a blog.

39. The computer session management system according to claim 1, wherein said safe access module is configured to operate on:
i) at least one first host computer; and
ii) at least one second host computer, each host computer operating under a separate operating system.

40-45. (canceled)

46. A method of providing advertising session management, comprising the steps of:
i) at a server, providing at least one advertisement, associated with at least one computer-based application, to a computer;
ii) entering an authentication identifier which is associated with said server into a confirmation module; and
iii) confirming said authentication identifier by said confirmation module;
iv) conditionally upon said authentication, providing said server safe access to said at least one computer-based application,

47. The method according to claim 46, including:
v) providing a concealed encryption engine configured to operate with the a host computer on at least one member of the group consisting of encryption of user-selected data thereon and concealing a portion of data thereon.

48. (canceled)

49. The computer advertising management system according to claim 1, further comprising
a gatekeeper associated with said safe access module, said gatekeeper configured to limit access to said computer based upon at least one parameter associated with said host computer, wherein said at least one parameter comprises a user identity.

50-51. (canceled)

52. The computer advertising management system according to claim 49, wherein said gatekeeper includes an authentication module associated with said safe access module, said authentication module configured to obtain authentication of said computer advertising session management system with respect to said host computer.

53-56. (canceled)

57. A method of providing advertising session management, comprising the steps of:
i) entering an authentication identifier into a computer network via a host computer;
ii) confirming said authentication identifier by a confirmation module operatively associated with said computer network;
iii) providing parameters associated with said authentication identifier to allow access to said computer network; and
iv) providing safe access to advertising associated with at least one computer-based application, using said computer network, conditionally upon said authentication, based upon said provided parameters.

58-64. (canceled)

65. The computer advertising session management system of claim 1, wherein said
safe access module is configured to facilitate safe access for advertising to an Internet access program in multiple operating systems in conjunction with said host computer and maintain a history of said advertising in said multiple operating systems.

66-68. (canceled)

69. The computer advertising session management system of claim 1, wherein said safe access module is configured to automatically facilitate safe access to an Internet access program following a connection, disconnection and reconnection with said Internet access program.

70-73. (canceled)

74. The computer advertising session management system of claim 1, wherein said safe access module is configured to facilitate safe access to multiple Web browsers during an Internet access session in conjunction with said host computer and maintain an advertising history associated with said multiple Web browsers.

75-77. (canceled)

78. The computer advertising session management system
of claim 1, further comprising an authentication module configured to obtain multiple authentications of said computer advertising session management system with respect to multiple users associated with said host computer; and wherein said advertising module is configured to provide advertisements associated with at least one computer-based application according to user profiles of each of said multiple users.

79-82. (canceled)

83. The computer advertising session management system according to claim 1, wherein said advertising module is configured to provide a display of at least one first advertisement overlay associated with at least one computer-based application based upon at least one control parameter, and said safe access module is operatively configured to facilitate safe access for said at least one first advertisement to said at least one computer-based application in conjunction with said computer.

84-86. (canceled)

87. The computer advertising session management system according to claim 83, wherein said at least one control parameter comprises at least one of:
i) time prior to said providing of said display of at least one first advertisement;
ii) time during said providing of said display of at least one first advertisement;
iii) time between providing of said display of at least one first advertisement and providing a display of at least one second advertisement;
iv) size of display peripheral to a copyrighted portion of said display; and
v) a user profile associated with said safe access module.

88. (canceled)

89. The computer advertising session management system of claim 1, wherein said
advertising module is configured to provide, in association with said at least one computer-based application, at least one of:
a) generic advertisements; and
b) targeted advertisements, based upon at least one user profile component associated with a user of said computer.

90-92. (canceled)

93. A system as claimed in claim 89, including a database for keeping a retrievable record of the user's Internet surfing history.
